(19) United States
(12) Patent Application Publication
(10) Pub. No.: US 2026/0238278 A1
(43) Pub. Date: Aug. 13, 2026

(54) SWITCHING TO ANOTHER MACHINE LEARNING MODEL

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 19/155,264

(22) PCT Filed: Feb. 27, 2024
(86) PCT No.: PCT/EP2024/054962

§ 371 Date: Aug. 11, 2025

(30) Foreign Application Priority Data
Feb. 27, 2023 (EP) 23158820.3

(51) Int. Cl. H04B 7/06; H04L 41/16; H04W 24/02

(52) U.S. Cl. CPC H04B 7/0626; H04L 41/16; H04W 24/02

(57) ABSTRACT

The disclosure pertains to a user equipment for a mobile telecommunications system, wherein the user equipment includes circuitry that is configured to: obtain performance information that indicates a performance of a first machine learning model for an operation of the mobile telecommunications system; decide, based on the performance information, to switch to another machine learning model for the operation of the mobile telecommunications system; and transmit to a network of the mobile telecommunications system an indication of the decision to switch.

### TECHNICAL FIELD

The present disclosure generally pertains to a user equipment, a base station, a circuitry and a method, in particular, to a user equipment, a base station, a circuitry and a method for a mobile telecommunications system.

### TECHNICAL BACKGROUND

Several generations of mobile telecommunications systems are known, e.g., the third generation (3G), which is based on the International Mobile Telecommunications-2000 (IMT-2000) specifications, the fourth generation (4G), which provides capabilities as defined in the International Mobile Telecommunications-Advanced Standard (IMT-Advanced Standard), and the current fifth generation (5G), which has recently been put into practice and which is still being developed further.

A wireless communication technology that provides the requirements of 5G is termed New Radio (NR) Access Technology. Some aspect of NR is based on Long Term Evolution (LTE) technology, which is a wireless communications technology allowing high-speed data communications for mobile phones and data terminals, and which is already used for 4G mobile telecommunications systems. LTE and NR are standardized under the control of 3GPP (3rd Generation Partnership Project).

NR provides for communication between a user equipment and a base station (gNB) through beams. This may include beam management, such as beam level mobility and beam failure recovery, as well as further operations of a mobile telecommunications network, such as determining channel state information (CSI) and positioning.

Although there exist techniques for an operation of a mobile telecommunications system, it is generally desirable to provide an improved base station, user equipment, circuitry and method that allow an improved operation of a mobile telecommunications system.

### SUMMARY

According to a first aspect, the disclosure provides a user equipment for a mobile telecommunications system, the user equipment comprising circuitry configured to: obtain performance information indicating a performance of a first machine learning model for an operation of the mobile telecommunications system; decide, based on the performance information, to switch to another machine learning model for the operation of the mobile telecommunications system; and transmit to a network of the mobile telecommunications system an indication of the decision to switch.

According to a second aspect, the disclosure provides a base station for a mobile telecommunications system, the base station comprising circuitry configured to: receive from a user equipment of the mobile telecommunications system an indication of a decision to switch from a first machine learning model for an operation of the mobile telecommunications system to another machine learning model for the operation of the mobile telecommunications system.

According to a third aspect, the disclosure provides a circuitry for a mobile telecommunications system, the circuitry being configured to: receive from a user equipment of the mobile telecommunications system an indication of a decision to switch from a first machine learning model for an operation of the mobile telecommunications system to another machine learning model for the operation of the mobile telecommunications system.

According to a fourth aspect, the disclosure provides a method for a user equipment of a mobile telecommunications system, the method comprising: obtaining performance information indicating a performance of a first machine learning model for an operation of the mobile telecommunications system; deciding, based on the performance information, to switch to another machine learning model for the operation of the mobile telecommunications system; and transmitting to a network of the mobile telecommunications system an indication of the decision to switch.

According to a fifth aspect, the disclosure provides a method for a mobile telecommunications system, the method comprising: receiving from a user equipment of the mobile telecommunications system an indication of a decision to switch from a first machine learning model for an operation of the mobile telecommunications system to another machine learning model for the operation of the mobile telecommunications system.

According to a sixth aspect, the disclosure provides a user equipment for a mobile telecommunications system, wherein the user equipment includes circuitry that is configured to: receive from a network of the mobile telecommunications system an indication of a decision to switch from a first machine learning model for an operation of the mobile telecommunications system to another machine learning model for the operation of the mobile telecommunications system.

According to a seventh aspect, the disclosure provides a base station for a mobile telecommunications system, wherein the base station includes circuitry that is configured to: obtain performance information that indicates a performance of a first machine learning model for an operation of the mobile telecommunications system; decide, based on the performance information, to switch to another machine learning model for the operation of the mobile telecommunications system; and transmit to a user equipment of the mobile telecommunications system an indication of the decision to switch.

According to an eighth aspect, the disclosure provides a circuitry for a mobile telecommunications system, wherein the circuitry is configured to: obtain performance information that indicates a performance of a first machine learning model for an operation of the mobile telecommunications system; decide, based on the performance information, to switch to another machine learning model for the operation of the mobile telecommunications system; and transmit to a user equipment of the mobile telecommunications system an indication of the decision to switch.

According to a ninth aspect, the disclosure provides a method for a user equipment of a mobile telecommunications system, wherein the method includes: receiving from a network of the mobile telecommunications system an indication of a decision to switch from a first machine learning model for an operation of the mobile telecommunications system to another machine learning model for the operation of the mobile telecommunications system.

According to a tenth aspect, the disclosure provides a method for a mobile telecommunications system, wherein the method includes: obtaining performance information that indicates a performance of a first machine learning model for an operation of the mobile telecommunications system; deciding, based on the performance information, to switch to another machine learning model for the operation of the mobile telecommunications system; and transmitting to a user equipment of the mobile telecommunications system an indication of the decision to switch.

According to an eleventh aspect, the disclosure provides a user equipment for a mobile telecommunication system, the user equipment comprising circuitry configured to: obtain an inference result of a first machine learning model for an operation of the mobile telecommunications system, wherein the first machine learning model is executed by the user equipment; determine a confidence level of the inference result; and transmit the inference result and an indication of the confidence level to a network of the mobile telecommunications system.

According to a twelfth aspect, the disclosure provides a base station for a mobile telecommunication system, the base station comprising circuitry configured to: receive, from a user equipment of the mobile telecommunications system, an inference result of a first machine learning model and an indication of a confidence level of the inference result, wherein the first machine learning model is executed by the user equipment for an operation of the mobile telecommunications system; determine a mismatch between the inference result of the first machine learning model and an inference result of a second machine learning model executed by the base station for the operation of the mobile telecommunications system; and decide to synchronize the first machine learning model with the second machine learning model based on the confidence level of the inference result of the first machine learning model.

According to a thirteenth aspect, the disclosure provides a circuitry for a mobile telecommunication system, the circuitry being configured to: receive, from a user equipment of the mobile telecommunications system, an inference result of a first machine learning model and an indication of a confidence level of the inference result, wherein the first machine learning model is executed by the user equipment for an operation of the mobile telecommunications system; determine a mismatch between the inference result of the first machine learning model and an inference result of a second machine learning model executed by the circuitry for the operation of the mobile telecommunications system; and decide to synchronize the first machine learning model with the second machine learning model based on the confidence level of the inference result of the first machine learning model.

According to a fourteenth aspect, the disclosure provides a method for a user equipment of a mobile telecommunication system, the method comprising: obtaining an inference result of a first machine learning model for an operation of the mobile telecommunications system, wherein the first machine learning model is executed by the user equipment; determining a confidence level of the inference result; and transmitting the inference result and an indication of the confidence level to a network of the mobile telecommunications system.

According to a fifteenth aspect, the disclosure provides a method for a mobile telecommunication system, the method comprising: receiving, from a user equipment of the mobile telecommunications system, an inference result of a first machine learning model and an indication of a confidence level of the inference result, wherein the first machine learning model is executed by the user equipment for an operation of the mobile telecommunications system; determining a mismatch between the inference result of the first machine learning model and an inference result of a second machine learning model executed by a network node of the mobile telecommunications system for the operation of the mobile telecommunications system; and deciding to synchronize the first machine learning model with the second machine learning model based on the confidence level of the inference result of the first machine learning model.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates a mobile telecommunications system according to an embodiment,

FIG. 2 illustrates embodiments with different types of machine learning models;

FIG. 3 illustrates a method in which a user equipment selects a machine learning model according to an embodiment with user-equipment-triggered switching;

FIG. 4 illustrates a method in which a user equipment requests a base station to switch models according to an embodiment with user-equipment-triggered switching;

FIG. 5 illustrates a method in which a user equipment requests a base station to select a machine learning model according to an embodiment with user-equipment-triggered switching;

FIG. 6 illustrates a method in which a base station switches a machine learning model according to an embodiment with network-triggered switching;

FIG. 7 illustrates a method in which a base station instructs a user equipment to switch a machine learning model according to an embodiment with network-triggered switching;

FIG. 8 illustrates a method according to an embodiment with two models;

FIG. 9 illustrates a user equipment and a base station according to an embodiment; and

FIG. 10 illustrates a general-purpose computer according to an embodiment.

### DETAILED DESCRIPTION OF EMBODIMENTS

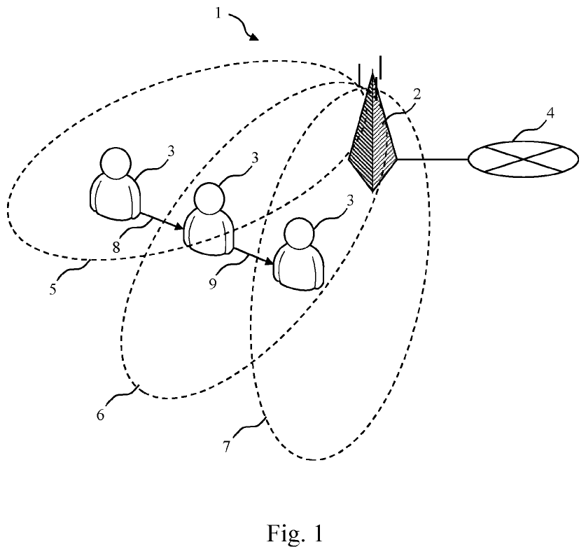

Before a detailed description of the embodiments under reference of FIG. 1 is given, general explanations are made.

As mentioned in the outset, several generations of mobile telecommunications systems are known, e.g., the third generation (3G), which is based on the International Mobile Telecommunications-2000 (IMT-2000) specifications, the fourth generation (4G), which provides capabilities as defined in the International Mobile Telecommunications-Advanced Standard (IMT-Advanced Standard), and the current fifth generation (5G), which has recently been put into practice and which is still being developed further.

A wireless communication technology that provides the requirements of 5G is termed New Radio (NR) Access Technology. Some aspect of NR is based on Long Term Evolution (LTE) technology, which is a wireless communications technology allowing high-speed data communications for mobile phones and data terminals, and which is already used for 4G mobile telecommunications systems. LTE and NR are standardized under the control of 3GPP (3rd Generation Partnership Project).

NR provides for communication between a user equipment (UE) and a base station (gNB) through beams. This may include beam management, such as beam level mobility and beam failure recovery. Beam level mobility allows switching the communication between the UE and the gNB from a first beam to a second beam, e.g., if a link quality of the first beam deteriorates. Beam failure recovery allows resuming the communication between the UE and the gNB after the communication through a beam has been interrupted. A communication between a UE and a gNB may as well include further operations of a mobile telecommunications network, such as determining channel state information (CSI) and positioning.

It has been recognized that artificial intelligence and/or machine learning (AI/ML) may improve beam management. For example, for beam level mobility, an AI/ML model may predict an advantageous time for switching from a first beam to a second beam, e.g., because a link quality of the first beam is expected to deteriorate and/or because a link quality of the second beam is expected to improve. For example, for beam failure recovery, an AI/ML model may predict one or more candidate beams that are expected to have a sufficient link quality for resuming the communication between the UE and the gNB after the communication through a serving beam has failed. Such changes in a link quality of a beam may be caused, e.g., by a movement of the UE. It has also been recognized that AI/ML may improve a further operation of a mobile telecommunications system, such as determining CSI and/or positioning.

Accordingly, a study item (SI) on AI/ML for a NR air interface has been approved. Objectives of the SI include beam management as a use case, e.g., beam prediction in time and/or spatial domain for overhead and latency reduction and/or beam selection accuracy improvement. The objectives of the SI also include, as a physical (PHY) layer aspect, a use case and collaboration level specific specification impact, such as new signaling, means for training and validation data assistance, assistance information, measurement and feedback. The objectives of the SI further include protocol aspects related to capability indication, configuration and control procedures (training/inference) and management of data and AI/ML models.

Agreements of the 3GPP Radio Access Network Work Group 1 (RAN1) on AI/ML for an NR air interface include studying, for a beam management case with a UE-side AI/ML model, a potential specification impact of layer 1 (L1) (physical layer) signaling to report, to a network, information related to AI/ML inference including a beam/beams that is/are based on an output of the AI/ML model inference, a predicted L1 Reference Signal Received Power (RSRP) corresponding to the beam(s) (which is for further study (FFS)) and other information (which is FFS).

The agreements of the 3 GPP RAN 1 further include studying, for a beam management case with a UE-side AI/ML model, a potential specification impact of L1 signaling to report, to the network, information related to AI/ML inference including a beam/beams of N future time instance(s) that is/are based on an output of the AI/ML model inference, the value of N (which is FFS), a predicted L1-RSRP corresponding to the beam(s) (which is FFS), information about a timestamp corresponding to the reported beam(s) (wherein it is FFS whether the timestamp is explicit or implicit) and other information (which is FFS).

As a working assumption for cases with a network-side AI/ML model, it has been agreed to study L1 beam reporting enhancements for an AI/ML model inference. The reporting enhancements include that a UE may report measurement results of more than four beams in one reporting instance. Other L1 reporting enhancements may also be considered.

In NR, beam level mobility is specified in TS 38.300 as follows:

“Beam Level Mobility does not require explicit RRC signalling to be triggered. Beam level mobility can be within a cell, or between cells, the latter is referred to as inter-cell beam management (ICBM). For ICBM, a UE can receive or transmit UE dedicated channels/signals via a TRP associated with a PCI different from the PCI of a serving cell, while non-UE-dedicated channels/signals can only be received via a TRP associated with a PCI of the serving cell. The gNB provides via RRC signalling the UE with measurement configuration containing configurations of SSB/CSI resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signalling, and RRC is not required to know which beam is being used at a given point in time.

SSB-based Beam Level Mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.”

In NR, beam failure detection and recovery are specified in TS 38.300 as follows:

“For beam failure detection, the gNB configures the UE with beam failure detection reference signals (SSB or CSI-RS) and the UE declares beam failure when the number of beam failure instance indications from the physical layer reaches a configured threshold before a configured timer expires. For beam failure detection in multi-TRP operation, the gNB configures the UE with two sets of beam failure detection reference signals each associated with a TRP, and the UE declares beam failure for a TRP when the number of beam failure instance indications associated with the corresponding set of beam failure detection reference signals from the physical layer reaches a configured threshold before a configured timer expires.

SSB-based Beam Failure Detection is based on the SSB associated to the initial DL BWP and can only be configured for the initial DL BWPs and for DL BWPs containing the SSB associated to the initial DL BWP. For other DL BWPs, Beam Failure Detection can only be performed based on CSI-RS.

After beam failure is detected on PCell, the UE:
triggers beam failure recovery by initiating a Random Access procedure on the PCell;
selects a suitable beam to perform beam failure recovery (if the gNB has provided dedicated Random Access resources for certain beams, those will be prioritized by the UE).
includes an indication of a beam failure on PCell in a BFR MAC CE if the Random Access procedure involves contention-based random access.

Upon completion of the Random Access procedure, beam failure recovery for PCell is considered complete.

After beam failure is detected on an SCell, the UE:
triggers beam failure recovery by initiating a transmission of a BFR MAC CE for this SCell;
selects a suitable beam for this SCell (if available) and indicates it along with the information about the beam failure in the BFR MAC CE.

Upon reception of a PDCCH indicating an uplink grant for a new transmission for the HARQ process used for the transmission of the BFR MAC CE, beam failure recovery for this SCell is considered complete.

After beam failure is detected for a TRP of Serving Cell, the UE:
triggers beam failure recovery by initiating a transmission of a BFR MAC CE for this TRP;
selects a suitable beam for this TRP (if available) and indicates whether the suitable (new) beam is found or not along with the information about the beam failure in the BFR MAC CE for this TRP.

Upon reception of a PDCCH indicating an uplink grant for a new transmission for the HARQ process used for the transmission of the BFR MAC CE for this TRP, beam failure recovery for this TRP is considered complete.

After beam failure is detected for both TRPs of PCell, the UE:
triggers beam failure recovery by initiating a Random Access procedure on the PCell;
selects a suitable beam for each failed TRP (if available) and indicates whether the suitable (new) beam is found or not along with the information about the beam failure in the BFR MAC CE for each failed TRP;
upon completion of the Random Access procedure, beam failure recovery for both TRPs of PCell is considered complete.”

It has been recognized that an introduction of AI/ML in an NR air interface may have impact on the beam management procedure, as indicated above. With an inference capability on neighbor beams and/or a serving beam, the beam management procedure can be greatly improved in some embodiments, e.g., a UE may switch to a suitable beam even before a beam failure happens.

A performance of an AI/ML model may be evaluated from both a network side and/or a UE side, depending on an adopted AI/ML model. Based on the performance evaluation, the AI/ML model may need to change (activation/deactivation) to improve its performance for a better beam management.

The present disclosure is concerned with what configurations and what information exchange may support a change of an AI/ML model for beam management.

An AI/ML model for beam management may need to be adjusted in order to improve a beam management performance. For example, a result of an evaluation of a beam management performance of a currently employed AI/ML model may indicate that another AI/ML model may yield a better performance. In such a case, it may be desirable to switch from the currently employed AI/ML model to the other AI/ML model. The present disclosure discusses how to support the AI/ML model change, e.g., depending on different AI/ML models that are being used.

Note that change signalling for changing an AI/ML model according to the present disclosure may be applicable to all AI/ML models used for managing and/or controlling connections over an air interface, e.g., to an AI/ML model for beam management (including, e.g., beam level mobility and/or beam failure recovery), to an AI/ML model for Channel State Information (CSI), and/or to an AI/ML model for positioning.

It has been agreed that, in some embodiments, an AI/ML model has a model identifier (ID) with associated information and/or model functionality at least for some AI/ML operations. An AI/ML model can be identified based on the model ID in the change signaling.

It has also been agreed that, in some embodiments, UE-sided models (where AI/ML model training and inference are performed at a UE side), network-sided models (where AI/ML model training and inference are performed at a UE side) and two-sided models (where AI/ML model training is performed at a NW side, and AI/ML model inference is performed at a UE side) are supported.

It has further been agreed that a UE may report to a network an inference result of a UE-sided model or of a two-sided model, e.g., an indication of beams with their predicted reference signal received power (RSRP). After the network has received this information from the UE, or after the network has obtained an inference result of a network-sided model, the network may configure corresponding beam information for beam management (e.g., beam level mobility or beam failure recovery) of the UE. Instead of or in addition to the beam information for beam management of the UE, the network may configure, based on the inference result, e.g., a determination of CSI and/or a positioning function.

When the UE has executed a beam management procedure (e.g., beam level mobility or beam failure recovery), the network may know whether an inference performance of the AI/ML model is satisfied or not, e.g., based on whether the UE has selected a candidate beam configured according to the inference result for beam level mobility or beam failure recovery, and/or based on a frequency of beam failure.

Further, when the UE has executed the beam management procedure, the UE may determine if a candidate beam configured according to the inference result and its predicted RSRP is accurate/feasible.

An additional performance matrix may include a beam prediction accuracy, a beam failure frequency, a percentage of selected beams that are included in pre-configured candidate beams etc.

Consequently, some embodiments of the disclosure pertain to a user equipment (UE) for a mobile telecommunications system, wherein the UE includes circuitry that is configured to: obtain performance information that indicates a performance of a first machine learning model for an operation of the mobile telecommunications system; decide, based on the performance information, to switch to another machine learning model for the operation of the mobile telecommunications system; and transmit to a network of the mobile telecommunications system an indication of the decision to switch.

The mobile telecommunications system may include, for example, New Radio (NR), 5G or any successor thereof, such as 6G.

The UE may include any device that is configured to connect to a base station of the mobile telecommunications system via an air interface according to a specification of the mobile telecommunications system. For example, the UE may include a smartphone, tablet computer, notebook, smart watch, smart glasses or the like. The UE may include a vehicle such as a car or a truck as well as a robot (e.g., a production robot and/or a self-driving robot), a drone (e.g., a quadcopter) or the like.

The circuitry may include a programmed microprocessor, an application-specific integrated circuit (ASIC), a field-programmable gate array (FPGA) or the like, that is capable of performing the processing described herein. The circuitry may include a storage unit, which may be based on flash memory, dynamic random-access memory (DRAM), electrically erasable programmable read-only memory (EEPROM) or the like. The storage unit may store instructions that, when executed by the circuitry, cause the circuitry to perform the processing. The circuitry may further include a communication interface, e.g., an antenna, for connecting to a base station via a NR air interface. For example, the circuitry may include a general-purpose computer as described with reference to FIG. 10.

For example, in a case that the first machine learning model serves for beam management, the performance of the first machine learning model may be determined based on whether a selected beam has been suggested by the first machine learning model as a candidate beam, how accurate the first machine learning model has predicted a link quality (e.g., RSRP) of a beam, how frequently a beam failure occurs after switching to a beam that has been suggested as a candidate beam by the first machine learning model, or the like. In a case that the first machine learning model serves for determining CSI, the performance may be determined based on comparing a predicted component of determined CSI with a result of a measurement of the respective component performed by the UE. In a case that the first machine learning model serves for positioning, the performance of the first machine learning model may be determined based on comparing a position of the UE that has been determined based on an inference result of the first machine learning model with a position of the UE that has been determined by other ways, e.g., based on available Wi-Fi networks with known positions, based on recognized features in a high-definition (HD) map and/or based on received radio-frequency identification (RFID) tags with a known position.

The obtaining of the performance information may include classifying the determined performance (e.g., into classes like “good”, “medium” or “bad”, without limiting the disclosure to these values) or quantifying the determined performance (e.g., to a value between 0 and 1, to a value between 0% and 100%, to a value between 0 and 255, or the like, without limiting the disclosure to these values). The performance information may indicate a result of the classification/quantification for indicating the performance of the first machine learning model.

The first machine learning model may include any artificial intelligence/machine learning (AI/ML) model that is capable of providing a prediction for the operation of the mobile telecommunications system, such as a predicted position of the UE at a certain time instance and/or a predicted link quality of a beam/channel at a certain position and/or time instance. For example, the machine learning model may include an algorithmic model such as a support vector machine (SVM) or a random forest, and/or may include a deep learning algorithm such as a Feed-Forward Network, a Residual Network (ResNet), a Recurrent Neural Network (RNN), a Convolutional Neural Network (CNN), a Generative Adversarial Network (GAN), a Transformer Neural Network and/or any other suitable neural network architecture.

The first machine learning model may be executed (e.g., evaluated) by the circuitry of the UE, by circuitry of a base station of the mobile telecommunications system and/or by circuitry provided in (a network node of) a core network of the mobile telecommunications system. If the machine learning model is not executed by the circuitry of the UE, the UE may receive an indication of an inference result of the first machine learning model from the base station and/or from the network node that executed the first machine learning model, or the UE may receive from the base station or network node a configuration that is based on the first machine learning model.

As indicated above, the first machine learning model may be configured as a UE-sided model, e.g., the UE may perform a training and an inference of the first machine learning model. The first machine learning model may be configured as a network-sided model, e.g., a core network of the mobile telecommunications system (e.g., a base station and/or a network node of the core network) may perform a training and an inference of the first machine learning model. The first machine learning model may be configured as a two-sided model, e.g., the core network (e.g., base station or network node) may perform a training of the first machine learning model, and the UE may perform an inference of the first machine learning model.

For example, for beam management, the first machine learning model may generate, as an inference result, an indication of one or more candidate beams (e.g., based on a position and/or a mobility state of the UE) for beam level mobility and/or for beam failure recovery. For example, the machine learning model may be trained based on former measurement results and/or beam failure events.

The UE may decide to switch to another machine learning model if the performance information indicates that the performance of the first machine learning model does not satisfy predefined requirements. For example, the UE may monitor the performance of the first machine learning model and decide to switch to another machine learning model based on the monitoring.

Accordingly, the UE may trigger a switching to another machine learning model. Embodiments in which the UE triggers a switching to another machine learning model may be referred to as embodiments with UE-triggered switching.

The switching to another machine learning model may include deactivating the first machine learning model and activating another machine learning model. For example, the UE may decide to trigger an activation/deactivation of different machine learning models, e.g., a deactivation of the first machine learning model and an activation of another machine learning model.

The transmitting of the indication of the decision to switch may be based on physical layer (L1) signaling, on Media Access Control (MAC) signaling and/or on radio resource control (RRC) signaling.

The network to which the UE transmits the indication of the decision to switch may include a core network of the mobile telecommunications system. The core network may include a base station with which the UE communicates. The core network may also include a further network node that may, for example, control the base station.

In some embodiments, the decision to switch to another machine learning model includes determining, based on the performance information, that the performance of the first machine learning model satisfies a switching condition configured by the network for switching to another machine learning model for the operation of the mobile telecommunications system.

For example, the network (e.g., a base station or (network node of) a core network of the mobile telecommunications system) may configure, as the switching condition, an event that may trigger switching to another machine learning model. The event may be defined based on one or more performance metrics, e.g., on a beam prediction accuracy, on a number of beam failures within a time period, on whether a number of missed targets (e.g., that a candidate beam indicated by the first machine learning model is not feasible) is beyond a threshold. For example, the UE may determine a number of beams selected within a pre-defined period that are not indicated by the first machine learning model as predicted candidate beams, which may mean that the predicted candidate beams are not suitable for the UE when the UE needs to switch the beam, and, thus, may indicate an inaccurate prediction by the first machine learning model. When the switching condition is satisfied, the UE may perform the deciding to switch to another machine learning model.

For example, if the performance information indicates a classification of the performance as described above, the switching condition may be fulfilled if the performance is classified as “bad”. For example, if the performance information indicates a quantization of the performance as described above, the switching condition may be fulfilled if a quantized value of the performance is below a predefined threshold, e.g., below 30%, below 50% or below 70% in a case of percentages or below equivalents thereof in other quantization schemes, without limiting the disclosure to these values. The skilled person may find other suitable thresholds or criteria for the switching condition. When the switching condition is fulfilled (e.g., if the UE determines that the switching condition is fulfilled) the UE may perform the deciding to switch to another machine learning model.

The network may configure the switching condition. Accordingly, the switching is UE-triggered but network-configured in some embodiments.

In some embodiments, the circuitry is further configured to switch, according to the decision to switch to another machine learning model, to a second machine learning model and execute an inference of the second machine learning model; and the transmitting of the indication of the decision to switch to another machine learning model includes reporting the switching to the second machine learning model to the network.

For example, the second machine learning model may be a UE-sided model. When the switching condition is satisfied, the UE may activate the second machine learning model. The UE may report to the network (e.g., to the base station or to (a network node of) the core network) that the UE has activated to the second machine learning model.

The first machine learning model may be a UE-sided model, and the UE may deactivate the first machine learning model when activating to the second machine learning model.

Upon receiving the report of the switching, the network may, e.g., determine a performance of the second machine learning model and/or synchronize a machine learning model executed by the network (e.g., a network-sided model) with the second machine learning model.

The first machine learning model may be a two-sided model, and the network may, upon receiving the report of the switching, stop training the first machine learning model.

The second machine learning model may be a two-sided model, and the network may, upon receiving the report of the switching, start training the second machine learning model.

The first machine learning model may be a network-sided model, and the network may, upon receiving the report of the switching, deactivate the first machine learning model and wait for receiving from the UE an inference result of the second machine learning model.

In some embodiments, the indication of the decision to switch to another machine learning model includes a request to switch to another machine learning model for the operation of the mobile telecommunications system.

The request to switch may request a network node of the network to switch to another machine learning model. The network node may include the base station of the mobile telecommunications system and/or another network node of the core network of the mobile telecommunications system.

For example, the network node may receive the indication of the decision to switch to another machine learning model, and may, based on the indication of the decision to switch, deactivate the first machine learning model. In some embodiments, the network node switches to a second machine learning model according to the request.

The network node may or may not transmit to the UE an indication of the second machine learning model to which the network node has switched.

For example, the network node may execute the first machine learning model (e.g., the first machine learning model may be a network-sided model), and the network node may switch from the first to the second machine learning model according to the request.

For example, the first machine learning model may be a UE-sided and/or a two-sided model, and the UE may stop executing the first machine learning model when the network node switches to the second machine learning model.

In some embodiments, the operation of the mobile telecommunications system includes beam management.

The beam management may include beam level mobility and beam failure recovery. An inference result of the first and/or second machine learning model may indicate one or more candidate beams to which the UE may switch when performing beam level mobility or beam failure recovery.

In some embodiments, the operation of the mobile telecommunications system includes determining channel state information (CSI).

The first and/or second machine learning model may be used for CSI feedback enhancement, e.g., for overhead reduction, improved accuracy and/or for prediction.

In some embodiments, the operation of the mobile telecommunications system includes positioning.

The first and/or second machine learning model may be used for positioning accuracy enhancements in different scenarios. Such scenarios may include, e.g., scenarios with heavy non-line-of-sight (NLOS) visibility conditions.

In some embodiments, the transmitting of the indication of the decision to switch to another machine learning model is based on physical layer signaling, e.g., on L1 signaling.

In some embodiments, the transmitting of the indication of the decision to switch to another machine learning model is based on Media Access Control (MAC) layer signaling.

In some embodiments, the transmitting of the indication of the decision to switch to another machine learning model is based on Radio Resource Control (RRC) layer signaling.

In some embodiments, the decision to switch to another machine learning model includes a decision to switch to a second machine learning model for the operation of the mobile telecommunications system; and the indication of the decision to switch to another machine learning model indicates an identifier of the second machine learning model.

For example, the UE may decide to switch to the second machine learning model and may indicate the second machine learning model to the network (e.g., base station and/or network node) by transmitting the identifier to the network.

In a case where the UE requests that the network executes the second machine learning model, the network (e.g., base station, network node and/or circuitry thereof) may activate the second machine learning model upon receiving the identifier of the second machine learning model.

In some embodiments, the decision to switch to another machine learning model includes a decision of a type of the other machine learning model; and the indication of the decision to switch to another machine learning model indicates the type of the other machine learning model.

The type of the other machine learning model may include UE-sided, network-sided and/or two-sided. For example, the UE may decide to switch to a UE-sided model, to a network-sided model and/or to a two-sided model, no matter if the first machine learning model is a UE-sided model, a network-sided model or a two-sided model.

The UE may indicate the decided type of the other machine learning model to the network. The UE and/or the network may activate and/or deactivate the first and second machine learning model accordingly.

Thus, the indication of the decision to switch to another machine learning model may include an identifier of another machine learning model, or may indicate a type (UE-sided/network-sided/two-sided) of a machine learning model, and the UE may report the selected machine learning model identifier or type to the network.

In some embodiments, the decision to switch to another machine learning model includes selecting a second machine learning model for switching; and the indication of the decision to switch identifies the selected second machine learning model.

The UE may select the second machine learning model (e.g., based on predefined criteria) and may report to the network (e.g., base station and/or network node) that the UE has selected the second machine learning model.

For example, when a switching condition for switching machine learning models is fulfilled, the UE may select the second machine learning model and identify the second machine learning model to the network.

The UE may select the second machine learning model for any one of a UE-sided model, a network-sided model and a two-sided model.

The UE may report the selected second machine learning model to the network based on physical layer (L1) signaling, MAC signaling and/or RRC signaling.

As described above, the UE may select a concrete machine learning model as the selected second machine learning model and report an identifier of the selected second machine learning model to the network. Alternatively, the UE may select a type of a machine learning model as the selected second machine learning model and report an indication of the selected type to the network. The UE may also select a concrete machine learning model and report to the network only a type but not an identifier of the selected concrete machine learning model.

For example, if the first machine learning model is a network-sided or two-sided model, the UE may report to the network “UE-sided model” as selected type, and the network may deactivate the first machine learning model.

For example, if the UE reports to the network “network-sided model” as selected type, the network may select and activate a concrete network-sided model.

In some embodiments, the indication of the decision to switch includes a selection request to select another machine learning model for switching; and the circuitry is further configured to receive from the network an indication of a selected second machine learning model for switching.

For example, the UE may request an indication of another machine learning model from the network (e.g., base station and/or network node), and the network may select the second machine learning model and transmit, to the UE, information that identifies the second machine learning model as the selected machine learning model. A model selection between the UE and the network may be synchronized.

For example, when a switching condition for switching machine learning models is fulfilled, the UE may request a selection of another machine learning model from the network, and the network may select and identify to the UE the second machine learning model.

The UE may have the network select the machine learning model for any one of a UE-sided model, a network-sided model and a two-sided model.

The network may reply to the UE with the selected second machine learning model based on physical layer (L1) signaling, MAC signaling and/or RRC signaling.

For example, upon receiving the selection request, the network may select the second machine learning model and indicate the second machine learning model to the UE. If the second machine learning model is a UE-sided or two-sided model, the UE may activate the second machine learning model.

For example, the second machine learning model may be a network-sided model, and the network may indicate to the UE that the network has selected a network-sided model. The UE may then deactivate the first machine learning model if the first machine learning model is a UE-sided or two-sided model.

Some embodiments pertain to a base station for a mobile telecommunications system, wherein the base station includes circuitry that is configured to: receive from a UE of the mobile telecommunications system an indication of a decision to switch from a first machine learning model for an operation of the mobile telecommunications system to another machine learning model for the operation of the mobile telecommunications system.

The base station may include a base station according to a specification of the mobile telecommunications system, e.g., a gNodeB (gNB) for NR, and may be configured to provide one or more beams to which one or more UEs may connect.

The base station may be provided on a network side of the mobile telecommunications system and may be connected with a core network of the mobile telecommunications system.

Similar to the circuitry of the UE described above, the circuitry of the base station may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 10.

The circuitry of the base station may be configured as a network-side counterpart of the UE described above for an embodiment with UE-triggered switching. Therefore, the base station (and/or its circuitry) may have any features that correspond to features described above with reference to the UE (and/or its circuitry).

Accordingly, in some embodiments, the circuitry is further configured to configure a switching condition for switching to another machine learning model for the operation of the mobile telecommunications system. In some embodiments, the receiving of the indication of the decision to switch to another machine learning model includes receiving a report that the UE has switched to the second machine learning model. In some embodiments, the indication of the decision to switch to another machine learning model includes a request to switch to another machine learning model for the operation of the mobile telecommunications system; and the circuitry is further configured to switch to a second machine learning model according to the request. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the receiving of the indication of the decision to switch to another machine learning model is based on physical layer (L1) signaling. In some embodiments, the receiving of the indication of the decision to switch to another machine learning model is based on Media Access Control (MAC) layer signaling. In some embodiments, the receiving of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model. In some embodiments, the decision to switch to another machine learning model includes selecting a second machine learning model for switching; and the indication of the decision to switch identifies the selected second machine learning model. In some embodiments, the indication of the decision to switch includes a selection request to select another machine learning model for switching; and the circuitry is further configured to: select a second machine learning model for switching according to the selection request; and transmit to the UE an indication of the selected second machine learning model.

Some embodiments pertain to a circuitry for a mobile telecommunications system, wherein the circuitry is configured to: receive from a UE of the mobile telecommunications system an indication of a decision to switch from a first machine learning model for an operation of the mobile telecommunications system to another machine learning model for the operation of the mobile telecommunications system.

The circuitry may be provided in a network node of a core network of the mobile telecommunications system. For example, the circuitry may communicate with a base station (such as the base station described above) of the mobile telecommunications system via the core network. The circuitry may further communicate with the UE of the mobile telecommunications system via the base station.

The circuitry may be configured as a network-side counterpart of the UE described above for an embodiment with UE-triggered switching. Thus, apart from being provided separately from the base station, the circuitry may be configured correspondingly like the (circuitry of) the base station of the telecommunications system described above, and the circuitry may have any features that correspond to features described above with reference to the base station (and/or its circuitry). For example, the circuitry may include a general-purpose computer as described with reference to FIG. 10.

Furthermore, the circuitry may include a graphics processing unit (GPU) and/or a tensor processing unit (TPU). Thus, the circuitry may be configured to train and/or execute the machine learning model faster and/or more energy efficient than a central processing unit (CPU) that is not specialized for evaluating the machine learning model (e.g., a deep neural network).

The circuitry provided in the core network may receive requests from one or more base stations of the mobile telecommunications system to train and/or execute machine learning models for one or more UEs connected to the one or more base stations. The circuitry may further receive input information for the machine learning models (e.g., measurement reports from the respective UEs that indicate link qualities of respective beams, mobility states of the respective UEs, or the like) from the base station(s) and input the received input information to the respective machine learning models. The circuitry may train and/or execute the respective machine learning models accordingly and may transmit inference results output from the respective machine learning models to the respective base station(s) and/or UEs.

Providing the circuitry for training and/or executing the machine learning model at a central site and/or for a plurality of base stations may allow a more efficient utilization of hardware for evaluating the machine learning model(s), a powerful electrical power supply that may not be available at every base station, a more efficient and/or more powerful cooling of the hardware and/or easier maintenance than if hardware for evaluating the machine learning model(s) were provided at each base station separately.

In some embodiments, the circuitry is further configured to configure a switching condition for switching to another machine learning model for the operation of the mobile telecommunications system. In some embodiments, the receiving of the indication of the decision to switch to another machine learning model includes receiving a report that the UE has switched to the second machine learning model. In some embodiments, the indication of the decision to switch to another machine learning model includes a request to switch to another machine learning model for the operation of the mobile telecommunications system; and the circuitry is further configured to switch to a second machine learning model according to the request. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the receiving of the indication of the decision to switch to another machine learning model is based on physical layer (L1) signaling. In some embodiments, the receiving of the indication of the decision to switch to another machine learning model is based on Media Access Control (MAC) layer signaling. In some embodiments, the receiving of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model. In some embodiments, the decision to switch to another machine learning model includes selecting a second machine learning model for switching; and the indication of the decision to switch identifies the selected second machine learning model. In some embodiments, the indication of the decision to switch includes a selection request to select another machine learning model for switching; and the circuitry is further configured to: select a second machine learning model for switching according to the selection request; and transmit to the UE an indication of the selected second machine learning model.

Some embodiments pertain to a method for a UE of a mobile telecommunications system, wherein the method includes: obtaining performance information that indicates a performance of a first machine learning model for an operation of the mobile telecommunications system; deciding, based on the performance information, to switch to another machine learning model for the operation of the mobile telecommunication system; and transmitting to a network of the mobile telecommunications system an indication of the decision to switch.

The method may be performed by (the circuitry of) the UE of the mobile telecommunications system described above. Accordingly, the method may have features corresponding to any features described above with respect to the UE.

In some embodiments, the decision to switch to another machine learning model includes determining, based on the performance information, that the performance of the first machine learning model satisfies a switching condition configured by the network for switching to another machine learning model for the operation of the mobile telecommunications system. In some embodiments, the method further includes switching, according to the decision to switch to another machine learning model, to a second machine learning model and executing an inference of the second machine learning model; and the transmitting of the indication of the decision to switch to another machine learning model includes reporting the switching to the second machine learning model to the network. In some embodiments, the indication of the decision to switch to another machine learning model includes a request to switch to another machine learning model for the operation of the mobile telecommunications system. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the transmitting of the indication of the decision to switch to another machine learning model is based on physical layer (L1) signaling. In some embodiments, the transmitting of the indication of the decision to switch to another machine learning model is based on Media Access Control (MAC) layer signaling. In some embodiments, the transmitting of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model. In some embodiments, the decision to switch to another machine learning model includes selecting a second machine learning model for switching; and the indication of the decision to switch identifies the selected second machine learning model. In some embodiments, the indication of the decision to switch includes a selection request to select another machine learning model for switching; and the method further includes receiving from the network an indication of a selected second machine learning model for switching.

Some embodiments pertain to a method for a mobile telecommunications system, wherein the method includes: receiving from a UE of the mobile telecommunications system an indication of a decision to switch from a first machine learning model for an operation of the mobile telecommunications system to another machine learning model for the operation of the mobile telecommunications system.

The method may be performed by (the circuitry of) the base station described above and/or by the circuitry (of a network node in the core network) described above. Accordingly, the method may have features corresponding to any features described above with respect to the base station and/or to the circuitry of the network node.

In some embodiments, the method further includes configuring a switching condition for switching to another machine learning model for the operation of the mobile telecommunications system. In some embodiments, the receiving of the indication of the decision to switch to another machine learning model includes receiving a report that the UE has switched to the second machine learning model. In some embodiments, the indication of the decision to switch to another machine learning model includes a request to switch to another machine learning model for the operation of the mobile telecommunications system; and the method further includes switching to a second machine learning model according to the request. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the receiving of the indication of the decision to switch to another machine learning model is based on physical layer (L1) signaling. In some embodiments, the receiving of the indication of the decision to switch to another machine learning model is based on Media Access Control (MAC) layer signaling. In some embodiments, the receiving of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model. In some embodiments, the decision to switch to another machine learning model includes selecting a second machine learning model for switching; and the indication of the decision to switch identifies the selected second machine learning model. In some embodiments, the indication of the decision to switch includes a selection request to select another machine learning model for switching; and the method further includes: selecting a second machine learning model for switching according to the selection request; and transmitting to the UE an indication of the selected second machine learning model.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, FIG. 1 illustrates a mobile telecommunications system 1 according to an embodiment. The mobile telecommunications system 1 includes a gNB 2 (which is an example of a base station 2), a user equipment (UE) 3 and a core network 4.

The gNB 2 provides beams 5, 6 and 7. The UE 3 connects to the gNB 2 via the beam 5. The gNB 2 is connected to the core network 4. The core network 4 includes network nodes (not shown) that control the gNB 2. The core network 4 further includes a gateway to the internet, such that the gNB 2 can provide to the UE 3 access to the internet via its connection to the core network 4.

The beams 5, 6 and 7 cover different but overlapping regions. The UE 3 is initially located in a region covered by the beam 5 and is connected to the gNB 2 via the beam 5.

Then, the UE 3 moves towards the beam 6, as indicated by an arrow 8. When the UE 3 has reached an edge of the beam 5 and is covered by the beam 6, a link quality of the beam 6 becomes better than a link quality of the beam 5. The UE 3 can therefore perform beam level mobility by switching from the beam 5 to the beam 6 for a better connection to the gNB 2. Candidate beam information generated as an inference result by a machine learning (ML) model indicates to the UE 3 that it should switch to the beam 6.

However, if the UE 3 does not perform beam level mobility, thus keeping the beam 5 as a serving beam, and moves further towards the beam 7, as indicated by an arrow 9, the UE 3 leaves the beam 5 and suffers from a beam failure. For recovering from the beam failure, the UE 3 can connect to the gNB 2 via the beam 6 or via the beam 7. Candidate beam information generated as an inference result by a machine learning (ML) model indicates to the UE 3 which one of the beam 6 and the beam 7 to use for beam failure recovery.

Beam level mobility and beam failure recovery, as described above, are examples of beam management. Beam management is an example of an operation of the mobile telecommunications system 1.

Another example of an operation of the mobile telecommunications system 1 is determining channel state information (CSI). When the UE 3 moves though the beams 5 to 7 provided by the gNB 2, the UE 3 performs measurements. Results of the measurements indicate a measured link quality of the beams 5 to 7 at respective positions. Based on the measured link quality, a ML model predicts a link quality of the respective beams 5 to 7 at positions where no measurements have been performed. The gNB 2 then determines the CSI based on such a predicted link quality.

A further example of an operation of the mobile telecommunications system 1 is positioning. Positioning includes determining a position of the UE 3 based on radio signals exchanged between the gNB 2 and the UE 3. In addition, for some positions of the UE 3, the UE 3 determines its position based on another positioning technique that is more reliable at the corresponding positions. Based on a difference of the position determined by the mobile telecommunications system 1 and by the other positioning technique, an ML model adjusts the positioning of the mobile telecommunications system 1 such that the mobile telecommunications system 1 can determine a position of the UE 3 (and of other UEs) more precisely.

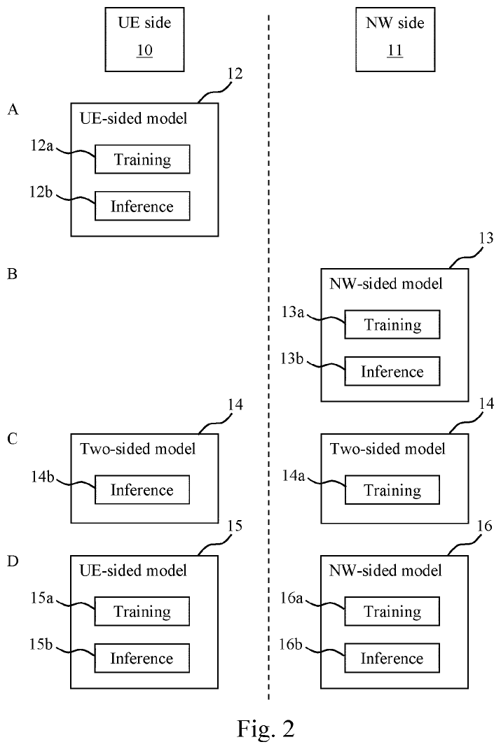

FIG. 2 illustrates embodiments with different types of machine learning models. The different types differ by which side of a mobile telecommunications system (e.g., of the mobile telecommunications system 1 of FIG. 1) is involved in executing a respective machine learning model.

A first side of the mobile telecommunications system is a UE side 10. The UE side includes a UE (e.g., the UE 3 of FIG. 1) of the mobile telecommunications system that is connected, via an air interface, to a base station (e.g., the gNB 2 of FIG. 1) of the mobile telecommunications system. A second side of the mobile telecommunications system includes a network (NW) side 11. The NW side 11 includes the base station to which the UE is connected as well as a network node of a core network (e.g., of the core network 4 of FIG. 1) of the mobile telecommunications system.

A of FIG. 2 illustrates a UE-sided model 12. For the UE-sided model 12, both training 12a and inference 12b are performed at the UE side 10.

B of FIG. 2 illustrates a NW-sided model 13. For the NW-sided model 13, both training 13a and inference 13b are performed at the NW side 11.

C of FIG. 2 illustrates a two-sided model 14. For the two-sided model 14, training 14a is performed at the NW side 11 and inference 14b is performed at the UE side 10.

D of FIG. 2 illustrates an embodiment with two models. A UE-sided model 15 including training 15a and inference 15b is performed at the UE side 10, and a NW-sided model 16 including training 16a and inference 16b is performed at the NW side 11. If a mismatch between inference results of the UE-sided model 15 and the NW-sided model 16 occurs, the UE-sided model 15 and the NW-sided model 16 are synchronized.

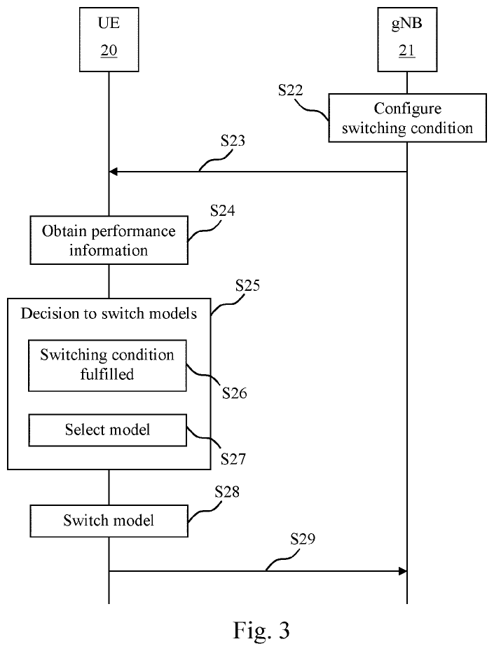

FIG. 3 illustrates a method in which a UE 20 selects a ML model according to an embodiment with UE-triggered switching. The method is performed by the UE 20 and a gNB 21 of a mobile telecommunications system. The UE 3 of FIG. 1 is an example of the UE 20, the gNB 2 of FIG. 1 is an example of the gNB 21, and the mobile telecommunications system 1 of FIG. 1 is an example of the mobile telecommunications system in which the UE 20 and the gNB 21 are included.

At the beginning of the method, the UE 20 executes a first machine learning (ML) model (i.e., a UE-sided model) for beam management.

At S22, the gNB 21 configures a switching condition for switching to another ML model for beam management and, at S23, transmits the switching condition to the UE 20.

At S24, the UE 20 obtains performance information that indicates a performance of the first ML model.

At S25, the UE 20 decides, based on the performance information, to switch to another ML model for beam management. The decision at S25 includes determining, at S26, based on the performance information, that the performance of the first ML model satisfies the switching condition configured by the gNB 21. The decision at S25 includes selecting, at S27, a second machine learning model for switching.

At S28, the UE 20 switches from the first ML model to the second ML model. Here, the second ML model is also a UE-sided model, and the UE 20 executes an inference of the second ML model. The switching at S28 includes deactivating the first ML model and activating the second ML model.

At S29, the UE 20 transmits, based on RRC layer signaling, to the gNB 21 an indication of the decision at S25. The indication at S29 includes a report of the switching to the second ML model at S28. The indication at S29 also indicates a unique identifier of the second ML model and a type (i.e., UE-sided model) of the second ML model. The gNB 21 receives the indication at S29.

It is noted that the first ML model may as well be a NW-sided model (executed by the gNB 21) or a two-sided model (trained by the gNB 21 and executed by the UE 20), and that the second ML model may as well be a two-sided model. It is also noted that the first ML model may as well be executed for determining CSI and/or for positioning. It is further noted that the transmitting at S29 may as well be based on MAC layer signaling and/or on L1 layer signaling. In addition, it is noted that, in some embodiments, the obtaining of performance information at S24 is performed before the configuring of the switching condition at S22 and/or before the transmitting of the switching condition at S23. Finally, it is noted that, in some embodiments, the method is performed by the UE 20 and, instead of the gNB 21, a network node of a core network (e.g., the core network 4 of FIG. 1) of the mobile telecommunications system.

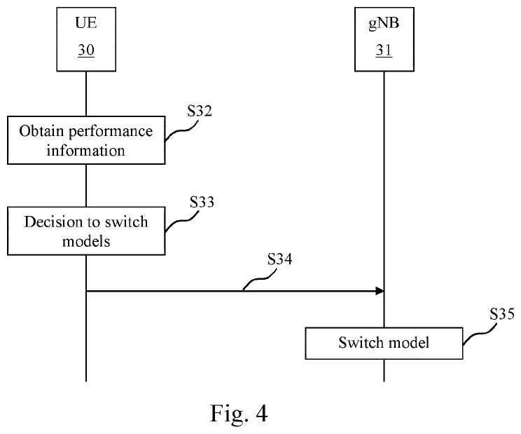

FIG. 4 illustrates a method in which a UE 30 requests a base station to switch models according to an embodiment with user-equipment-triggered switching. The method is performed by the UE 30 and a gNB 31 (an example of a base station) of a mobile telecommunications system. The UE 3 of FIG. 1 is an example of the UE 30, the gNB 2 of FIG. 1 is an example of the gNB 31, and the mobile telecommunications system 1 of FIG. 1 is an example of the mobile telecommunications system in which the UE 30 and the gNB 31 are included.

At the beginning of the method, the gNB 31 executes a first ML model (i.e., a NW-sided model) for beam management.

At S32, the UE 30 obtains performance information of the first ML model, corresponding to the obtaining of performance information at S24 of FIG. 3. The performance information indicates a performance of the first ML model.

At S33, the UE 30 decides, based on the performance information, to switch to another ML model for beam management.

At S34, the UE 30 transmits, based on RRC layer signaling, an indication of the decision at S33 to switch to the gNB 31. The indication of the decision at S34 includes a request to switch to another ML model for beam management. The gNB 31 receives the indication at S34.

At S35, the gNB 31 switches to a second ML model according to the request to switch at S34 and executes an inference of the second ML model. The second ML model is a NW-sided model executed by the gNB 31.

It is noted that the first ML model may as well be a UE-sided model (executed by the UE 30) or a two-sided model (trained by the gNB 31 and executed by the UE 30), and that the second ML model may as well be a two-sided model. It is also noted that the first and the second ML model may as well be executed for determining CSI and/or for positioning. It is further noted that the transmitting at S34 may as well be based on MAC layer signaling and/or on L1 layer signaling. In addition, it is noted that, in some embodiments, the method is performed by the UE 30 and, instead of the gNB 31, a network node of a core network (e.g., the core network 4 of FIG. 1) of the mobile telecommunications system.

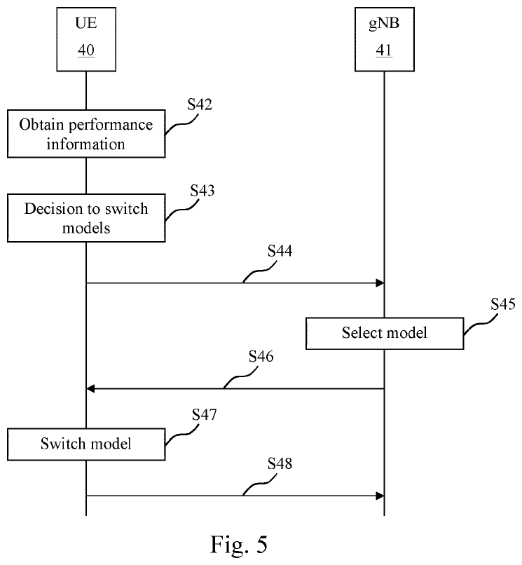

FIG. 5 illustrates a method in which a UE 40 requests a base station to select a ML model according to an embodiment with UE-triggered switching. The method is performed by the UE 40 and a gNB 41 (an example of a base station) of a mobile telecommunications system. The UE 3 of FIG. 1 is an example of the UE 40, the gNB 2 of FIG. 1 is an example of the gNB 41, and the mobile telecommunications system 1 of FIG. 1 is an example of the mobile telecommunications system in which the UE 40 and the gNB 41 are included.

At the beginning of the method, the UE 40 executes a first ML model (i.e., a UE-sided model) for beam management.

At S42, the UE 40 obtains performance information of the first ML model, corresponding to the obtaining of performance information at S24 of FIG. 3. The performance information indicates a performance of the first ML model.

At S43, the UE 40 decides, based on the performance information, to switch to another ML model for beam management.

At S44, the UE 40 transmits, based on RRC layer signaling, an indication of the decision at S43 to switch to the gNB 41. The indication of the decision at S44 includes a selection request to select another ML model for switching. The gNB 41 receives the indication at S44.

At S45, the gNB 41 selects a second ML model for switching according to the selection request at S44.

At S46, the gNB 41 transmits, based on RRC layer signaling, an indication of the second ML model, which has been selected at S45, to the UE 40. The UE 40 receives the indication at S46.

At S47, the UE 20 switches from the first ML model to the second ML model according to the indication at S46. Here, the second ML model is also a UE-sided model, and the UE 40 executes an inference of the second ML model. The switching at S47 includes deactivating the first ML model and activating the second ML model.

At S48, the UE 40 reports, based on RRC layer signaling, the switching to the second ML model to the gNB 41.

It is noted that the first ML model may as well be a NW-sided model (executed by the gNB 41) or a two-sided model (trained by the gNB 41 and executed by the UE 40), and that the second ML model may as well be a two-sided model. It is also noted that the first and the second ML model may as well be executed for determining CSI and/or for positioning. It is further noted that the transmitting at S44, S46 and/or S48 may as well be based on MAC layer signaling and/or on L1 layer signaling. In addition, it is noted that, in some embodiments, the method is performed by the UE 40 and, instead of the gNB 41, a network node of a core network (e.g., the core network 4 of FIG. 1) of the mobile telecommunications system.

Furthermore, some embodiments pertain to a user equipment (UE) for a mobile telecommunications system, wherein the UE includes circuitry that is configured to: receive from a network of the mobile telecommunications system an indication of a decision to switch from a first machine learning model for an operation of the mobile telecommunications system to another machine learning model for the operation of the mobile telecommunications system.

The network may perform the decision to switch to another machine learning model. Accordingly, the network may trigger a switching to another machine learning model. Embodiments in which the network triggers a switching to another machine learning model may be referred to as embodiments with network-triggered switching, in contrast to embodiments with UE-triggered switching as described above.

Thus, apart from the feature that the decision to switch to another machine learning model is made by the network instead of by the UE and from corresponding differences, some embodiments with network-triggered switching may have features that correspond to features of embodiments with UE-triggered switching.

For example, similar to the embodiments with UE-triggered switching described above, the mobile telecommunications system may include, for example, NR, 5G or any successor thereof, such as 6G, and the UE may include any device that is configured to connect to a base station of the mobile telecommunications system via an air interface according to a specification of the mobile telecommunications system, including the example of a UE described above. The UE may be provided on a UE side of the mobile telecommunications system.

Similar to the circuitry of the UE described above for embodiments with UE-triggered switching, the circuitry of the UE may include a programmed microprocessor, an ASIC, an FPGA or the like, a storage unit and a communication interface, which may be configured as for the UE described above for embodiments with UE-triggered switching. For example, the circuitry may include a general-purpose computer as described with reference to FIG. 10.

Likewise, the network may include a core network of the mobile telecommunications system and may include (a circuitry of) a base station and/or (a circuitry of) a network node in the network, as described above for embodiments with UE-triggered switching.

The receiving of the indication of the decision to switch may correspond to the corresponding receiving of an indication of a decision to switch described above for embodiments with UE-triggered switching, apart from the difference that, in some embodiments with network-triggered switching, the receiving is performed by the UE instead of by (a base station and/or circuitry (of a network node) of) the network.

The first machine learning model may correspond to the first machine learning model described above for embodiments with UE-triggered switching, and the decision to switch from the first machine learning model to another machine learning model may correspond to the decision to switch from the first machine learning model to another machine learning model described above for embodiments with UE-triggered switching, apart from the difference that the decision is made by the network instead of by the UE.

Similarly, the first machine learning model and the operation of the mobile telecommunications system may correspond to the first machine learning model and the operation of the mobile telecommunications system, respectively, as described above with respect to a UE-triggered switching of machine learning models.

Further embodiments with network-triggered switching, as described in the following, may correspond to according embodiments with UE-triggered switching. A detailed description of features of embodiments with network-triggered switching that are described above accordingly for embodiments with UE-triggered switching is omitted for brevity.

In some embodiments, the receiving of the indication of the decision to switch to another machine learning model includes receiving a report that the network has switched to the second machine learning model.

The network may not have to indicate the second machine learning model (e.g., an identifier and/or a type of the second machine learning model) to the UE. For example, the network may not indicate the second machine learning model to the UE if the switching from the first to the second machine learning model does not require an action of the UE (e.g., if both the first and the second machine learning models are network-sided models).

In some embodiments, the indication of the decision to switch to another machine learning model includes an instruction to switch to another machine learning model for the operation of the mobile telecommunications system; and the circuitry is further configured to switch to a second machine learning model according to the instruction.

The instruction may be based on the decision to switch to another machine learning model and may instruct the UE to perform the switching.

In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the receiving of the indication of the decision to switch to another machine learning model is based on physical layer (L1) signaling. In some embodiments, the receiving of the indication of the decision to switch to another machine learning model is based on Media Access Control (MAC) layer signaling. In some embodiments, the receiving of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and wherein the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model.

Some embodiments pertain to a base station for a mobile telecommunications system, wherein the base station includes circuitry that is configured to: obtain performance information that indicates a performance of a first machine learning model for an operation of the mobile telecommunications system; decide, based on the performance information, to switch to another machine learning model for the operation of the mobile telecommunications system; and transmit to a UE of the mobile telecommunications system an indication of the decision to switch.

Similar to the base station described above for embodiments with UE-triggered switching, the mobile telecommunications system may include, for example, NR, 5G or any successor thereof, such as 6G, and the base station may be a base station according to a specification of the mobile telecommunications system, e.g., a gNB for NR, and may be configured to provide one or more beams to which one or more UEs may connect.

The base station may be provided on a network side of the mobile telecommunications system and may be connected with a core network of the mobile telecommunications system.

Similar to the circuitry of the base station described above for embodiments with UE-triggered switching, the circuitry of the base station may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 10.

The circuitry of the base station may be configured as a network-side counterpart of the UE described above for an embodiment with network-triggered switching. The base station and/or its circuitry may have the following features, which correspond to respective features described above for a UE of an embodiment with network-triggered switching.

In some embodiments, the circuitry is further configured to switch, according to the decision to switch to another machine learning model, to a second machine learning model and execute an inference of the second machine learning model; and the transmitting of the indication of the decision to switch to another machine learning model includes reporting the switching to the second machine learning model to the UE. In some embodiments, the indication of the decision to switch to another machine learning model includes an instruction to switch to another machine learning model for the operation of the mobile telecommunications system. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the transmitting of the indication of the decision to switch to another machine learning model is based on physical layer (L1) signaling. In some embodiments, the transmitting of the indication of the decision to switch to another machine learning model is based on Media Access Control (MAC) layer signaling. In some embodiments, the transmitting of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model.

Some embodiments pertain to a circuitry for a mobile telecommunications system, wherein the circuitry is configured to: obtain performance information that indicates a performance of a first machine learning model for an operation of the mobile telecommunications system; decide, based on the performance information, to switch to another machine learning model for the operation of the mobile telecommunications system; and transmit to a UE of the mobile telecommunications system an indication of the decision to switch.

The circuitry may be provided in a network node of a core network of the mobile telecommunications system. For example, the circuitry may communicate with a base station of the mobile telecommunications system via the core network. The circuitry may further communicate with the UE of the mobile telecommunications system, as described above for embodiments with network-triggered switching, via the base station.

Like the circuitry of a network node described above for embodiments with UE-triggered switching, the circuitry may be configured correspondingly as a network-side counterpart of a UE of an embodiment with network-triggered switching and may, apart from being provided separately from the base station, be configured correspondingly like the (circuitry of) the base station of the telecommunications system described above. Accordingly, the circuitry may have any features that correspond to features described above with reference to the base station (and/or its circuitry). For example, the circuitry may include a general-purpose computer as described with reference to FIG. 10.

Like the circuitry of a network node described above for embodiments with UE-triggered switching, the circuitry may include a GPU and/or a TPU for faster and/or more energy efficient training and/or execution of the machine learning model. As described above, the circuitry may train and/or execute the machine learning model for a plurality of base stations, which may have the advantages described above.

In some embodiments, the circuitry is further configured to switch, according to the decision to switch to another machine learning model, to a second machine learning model and execute an inference of the second machine learning model; and the transmitting of the indication of the decision to switch to another machine learning model includes reporting the switching to the second machine learning model to the UE. In some embodiments, the indication of the decision to switch to another machine learning model includes an instruction to switch to another machine learning model for the operation of the mobile telecommunications system. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the transmitting of the indication of the decision to switch to another machine learning model is based on physical layer (L1) signaling. In some embodiments, the transmitting of the indication of the decision to switch to another machine learning model is based on Media Access Control (MAC) layer signaling. In some embodiments, the transmitting of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model.

Some embodiments pertain to a method for a UE of a mobile telecommunications system, wherein the method includes: receiving from a network of the mobile telecommunications system an indication of a decision to switch from a first machine learning model for an operation of the mobile telecommunications system to another machine learning model for the operation of the mobile telecommunications system.

The method may be performed by (the circuitry of) the UE of the mobile telecommunications system described above for embodiments with network-triggered switching. Accordingly, the method may have features corresponding to any features described above with respect to the UE.

In some embodiments, the receiving of the indication of the decision to switch to another machine learning model includes receiving a report that the network has switched to the second machine learning model. In some embodiments, the indication of the decision to switch to another machine learning model includes an instruction to switch to another machine learning model for the operation of the mobile telecommunications system; and the method further includes switching to a second machine learning model according to the instruction. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the receiving of the indication of the decision to switch to another machine learning model is based on physical layer (L1) signaling. In some embodiments, the receiving of the indication of the decision to switch to another machine learning model is based on Media Access Control (MAC) layer signaling. In some embodiments, the receiving of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model.

Some embodiments pertain to a method for a mobile telecommunications system, wherein the method includes: obtaining performance information that indicates a performance of a first machine learning model for an operation of the mobile telecommunications system; deciding, based on the performance information, to switch to another machine learning model for the operation of the mobile telecommunications system; and transmitting to a UE of the mobile telecommunications system an indication of the decision to switch.

The method may be performed by (the circuitry of) the base station and/or the circuitry (of a network node in the core network) described above for embodiments with network-triggered switching. Accordingly, the method may have features corresponding to any features described above with respect to the base station and/or to the circuitry of the network node.

In some embodiments, the method further includes switching, according to the decision to switch to another machine learning model, to a second machine learning model and execute an inference of the second machine learning model; and the transmitting of the indication of the decision to switch to another machine learning model includes reporting the switching to the second machine learning model to the UE. In some embodiments, the indication of the decision to switch to another machine learning model includes an instruction to switch to another machine learning model for the operation of the mobile telecommunications system. In some embodiments, the operation of the mobile telecommunications system includes beam management. In some embodiments, the operation of the mobile telecommunications system includes determining channel state information (CSI). In some embodiments, the operation of the mobile telecommunications system includes positioning. In some embodiments, the transmitting of the indication of the decision to switch to another machine learning model is based on physical layer (L1) signaling. In some embodiments, the transmitting of the indication of the decision to switch to another machine learning model is based on Media Access Control (MAC) layer signaling. In some embodiments, the transmitting of the indication of the decision to switch to another machine learning model is based on Radio Resource Control (RRC) layer signaling. In some embodiments, the decision to switch to another machine learning model includes a decision to switch to a second machine learning model for the operation of the mobile telecommunications system; and the indication of the decision to switch to another machine learning model indicates an identifier of the second machine learning model. In some embodiments, the decision to switch to another machine learning model includes a decision of a type of the other machine learning model; and the indication of the decision to switch to another machine learning model indicates the type of the other machine learning model.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

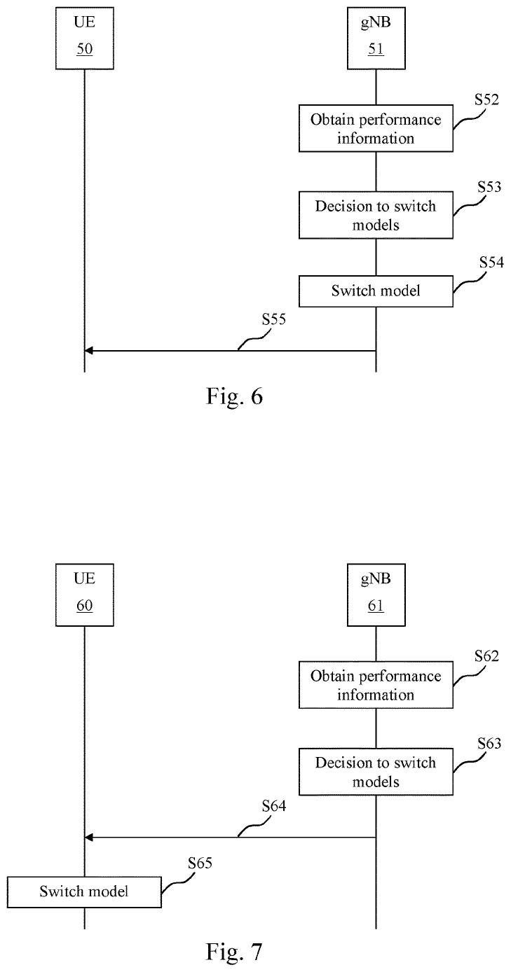

FIG. 6 illustrates a method in which a base station switches a machine learning model according to an embodiment with network-triggered switching. The method is performed by a UE 50 and a gNB 51 (an example of a base station) of a mobile telecommunications system. The UE 3 of FIG. 1 is an example of the UE 50, the gNB 2 of FIG. 1 is an example of the gNB 51, and the mobile telecommunications system 1 of FIG. 1 is an example of the mobile telecommunications system in which the UE 50 and the gNB 51 are included.

At the beginning of the method, the gNB 51 executes a first ML model (i.e., a NW-sided model) for beam management.

At S52, the gNB 51 obtains performance information of the first ML model, similar to the obtaining of performance information at S24 of FIG. 3. The performance information indicates a performance of the first ML model.

At S53, the gNB 51 decides, based on the performance information, to switch to another ML model for beam management.

At S54, the gNB 51 switches, according to the decision at S53 to switch, from the first ML model to a second ML model according to the decision at S53. Here, the second ML model is also a NW-sided model, and the gNB 51 executes an inference of the second ML model. The switching at S54 includes deactivating the first ML model and activating the second ML model.

At S55, the gNB 51 reports, based on RRC layer signaling, the switching to the second ML model to the UE 50.

It is noted that the first ML model may as well be a UE-sided model (executed by the UE 50) or a two-sided model (trained by the gNB 51 and executed by the UE 50), and that the second ML model may as well be a two-sided model. It is also noted that the first and the second ML model may as well be executed for determining CSI and/or for positioning. It is further noted that the transmitting at S55 may as well be based on MAC layer signaling and/or on L1 layer signaling. In addition, it is noted that, in some embodiments, the method is performed by the UE 50 and, instead of the gNB 51, a network node of a core network (e.g., the core network 4 of FIG. 1) of the mobile telecommunications system.

FIG. 7 illustrates a method in which a base station instructs a UE to switch a machine learning model according to an embodiment with network-triggered switching. The method is performed by a UE 60 and a gNB 61 (an example of a base station) of a mobile telecommunications system. The UE 3 of FIG. 1 is an example of the UE 60, the gNB 2 of FIG. 1 is an example of the gNB 61, and the mobile telecommunications system 1 of FIG. 1 is an example of the mobile telecommunications system in which the UE 60 and the gNB 61 are included.

At the beginning of the method, the UE 60 executes a first ML model (i.e., a UE-sided model) for beam management.

At S62, the gNB 61 obtains performance information of the first ML model, similar to the obtaining of performance information at S24 of FIG. 3. The performance information indicates a performance of the first ML model.

At S63, the gNB 61 decides, based on the performance information, to switch to another ML model for beam management.

At S64, the gNB 61 transmits, based on RRC layer signaling, an indication of the decision at S63 to switch to the UE 60. The indication of the decision at S64 includes an instruction to switch to another ML model for beam management. The UE 60 receives the indication at S64.

At S65, the UE 60 switches to a second ML model according to the instruction to switch at S64 and executes an inference of the second ML model. The second ML model is a UE-sided model executed by the UE 60.

It is noted that the first ML model may as well be a NW-sided model (executed by the gNB 61) or a two-sided model (trained by the gNB 61 and executed by the UE 60), and that the second ML model may as well be a two-sided model. It is also noted that the first and the second ML model may as well be executed for determining CSI and/or for positioning. It is further noted that the transmitting at S64 may as well be based on MAC layer signaling and/or on L1 layer signaling. In addition, it is noted that, in some embodiments, the method is performed by the UE 60 and, instead of the gNB 61, a network node of a core network (e.g., the core network 4 of FIG. 1) of the mobile telecommunications system.

Furthermore, some embodiments pertain to a user equipment (UE) for a mobile telecommunication system, wherein the UE includes circuitry that is configured to: obtain an inference result of a first machine learning model for an operation of the mobile telecommunications system, wherein the first machine learning model is executed by the UE; determine a confidence level of the inference result; and transmit the inference result and an indication of the confidence level to a network of the mobile telecommunications system.

The network (e.g., a base station or a network node in the network) may execute a second machine learning model for the operation of the mobile telecommunications system and may obtain an inference result of the second machine learning model. For example, the UE may execute a UE-sided model and the network may execute a network-sided model for a same operation of the mobile telecommunications system. The network may determine a mismatch between the inference results of the first machine learning model and of the second machine learning model and may decide to synchronize the first machine learning model with the second machine learning model based on the confidence level of the inference result of the first machine learning model.

Accordingly, embodiments in which a UE executes a first machine learning model and a network executes a second machine learning model may be referred to as embodiments with two models. Apart from features described specifically for embodiments with two models, the UE, the mobile telecommunications system, the circuitry, the (first) machine learning model, the operation of the mobile telecommunications system and the network of an embodiment with two models may correspond to a UE, a mobile telecommunications system, a circuitry, a machine learning model, an operation of a mobile telecommunications system and a network, respectively, as described above for embodiments with UE-triggered switching and/or for embodiments with network-triggered switching.

For example, similar to the embodiments with UE-triggered switching and/or with network-triggered switching described above, the mobile telecommunications system may include, for example, NR, 5G or any successor thereof, such as 6G, and the UE may include any device that is configured to connect to a base station of the mobile telecommunications system via an air interface according to a specification of the mobile telecommunications system, including the example of a UE described above for embodiments with UE-triggered switching and/or with network-triggered switching. The UE may be provided on a UE side of the mobile telecommunications system.

Similar to the circuitry of the UE described above for embodiments with UE-triggered switching and/or with network-triggered switching, the circuitry of the UE may include a programmed microprocessor, an ASIC, an FPGA or the like, a storage unit and a communication interface, which may be configured as for the UE described above for embodiments with UE-triggered switching. For example, the circuitry may include a general-purpose computer as described with reference to FIG. 10.

Likewise, the network may include a core network of the mobile telecommunications system and may include (a circuitry of) a base station and/or (a circuitry of) a network node in the network, as described above for embodiments with UE-triggered switching.

The inference result may indicate a parameter of the operation of the mobile telecommunications network that has been predicted by the first or second machine learning model. For example, the inference result may indicate a predicted beam, a predicted link quality of a beam at a certain position and/or time instance, a predicted position or mobility state of a UE or the like.

The confidence level may indicate an uncertainty of the inference result. The confidence level may correspond to and/or may be based on a confidence interval of the inference result. For example, the confidence level may include a percentage.

For example, the mismatch between the inference results of the first and the second machine learning models may correspond to predictions that are incompatible to each other and/or to a difference between respective predicted values that exceeds a predefined threshold.

The network may decide to synchronize the first and the second machine learning model in order to avoid a future mismatch between inference results of the first and the second machine learning models.

For example, there may be scenarios that an adopted (e.g., activated) machine learning model at a UE side and at a network side may be mismatched. For example, different models may be selected at the UE side and the network side, or there may be multiple machine learning models activated at the UE side and the network side, and this may lead to scenarios where an inference result from the UE side and an inference result from the network side are different.

To solve these problems, the UE may send the inference result from the UE-sided model to the network together with a confidence index level that may indicate to the network whether the inference result is reliable in a case that there is a mismatch between the UE side and the network side. Based on the mismatched inferences, the network may synchronize a machine learning model between the UE and the network, e.g., change the machine learning model on the UE side.

With respect to these solutions, it is noted that it may be the network to configure the UE with candidate beam information for beam mobility. Thus, the network may decide which inference result to select in case of a mismatch between inference results from the UE side and the network side.

The transmitting (by the UE) and receiving (by the network) of the inference result and/or of the confidence level to the network may be based on L1 signaling, on MAC layer signaling and/or on RRC layer signaling.

In some embodiments, the transmitting of at least one of the inference result and the indication of the confidence level is based on physical (L1) layer signaling.

In some embodiments, the transmitting of at least one of the inference result and the indication of the confidence level is based on Media Access Control (MAC) layer signaling.

In some embodiments, the transmitting of at least one of the inference result and the indication of the confidence level is based on Radio Resource Control (RRC) layer signaling.

In some embodiments, the circuitry is further configured to: receive, in response to the transmitting of the inference result and the indication of the confidence level, from the network an instruction to synchronize the first machine learning model with a second machine learning model executed by the network for the operation of the mobile telecommunications system.

For example, the network may determine a mismatch between the inference results of the first machine learning model and of the second machine learning model. For avoiding a future mismatch between inference results of the first and the second machine learning model, the network may decide to synchronize the first and the second machine learning model such that they yield matching inference results.

For example, the synchronizing may include switching from the one of the first and the second machine learning models whose inference results have a lower confidence level to a machine learning model that corresponds to the one of the first and the second machine learning models whose inference results have a higher confidence level.

The transmitting (by the network) and receiving (by the UE) of the instruction to synchronize the first machine learning model may be based on L1 signaling, on MAC layer signaling and/or on RRC layer signaling.

In some embodiments, the synchronizing includes switching from the first machine learning model to another machine learning model that corresponds to the second machine learning model.

The instruction to synchronize may include an indication (e.g., a unique identifier) of a machine learning model to which the UE should switch from the first machine learning model.

For example, the network may determine, based on the confidence level of the inference result of the first machine learning model, that a confidence level of the inference result of the second machine learning model is higher than the confidence level of the inference result of the first machine learning model, and that, accordingly, the UE should switch from the first machine learning model to a machine learning model that corresponds to the second machine learning model in order to avoid a future mismatch between inference results obtained by the UE and by the network.

In some embodiments, the receiving of the instruction to synchronize the first machine learning model is based on physical (L1) layer signaling.

In some embodiments, the receiving of the instruction to synchronize the first machine learning model is based on Media Access Control (MAC) layer signaling.

In some embodiments, the receiving of the instruction to synchronize the first machine learning model is based on Radio Resource Control (RRC) layer signaling.

In some embodiments, the operation of the mobile telecommunications system includes beam management.

In some embodiments, the operation of the mobile telecommunications system includes determining channel state information (CSI).

In some embodiments, the operation of the mobile telecommunications system includes positioning.

Some embodiments pertain to a base station for a mobile telecommunication system, wherein the base station includes circuitry that is configured to: receive, from a UE of the mobile telecommunications system, an inference result of a first machine learning model and an indication of a confidence level of the inference result, wherein the first machine learning model is executed by the UE for an operation of the mobile telecommunications system; determine a mismatch between the inference result of the first machine learning model and an inference result of a second machine learning model executed by the base station for the operation of the mobile telecommunications system; and decide to synchronize the first machine learning model with the second machine learning model based on the confidence level of the inference result of the first machine learning model.

Similar to the base stations described above for the embodiments with UE-triggered switching and/or with network-triggered switching, the base station may include a base station according to a specification of the mobile telecommunications system, e.g., a gNodeB (gNB) for NR, and may be configured to provide one or more beams to which one or more UEs may connect.

The base station may be provided on a network side of the mobile telecommunications system and may be connected with a core network of the mobile telecommunications system.

Similar to the circuitry of the base stations described above for embodiments with UE-triggered switching and/or with network-triggered switching, the circuitry of the base station may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 10.

The circuitry of the base station may be configured as a network-side counterpart of the UE described above for an embodiment with two models. Therefore, the base station (and/or its circuitry) may have any features that correspond to features described above with reference to the UE (and/or its circuitry).

In some embodiments, the receiving of at least one of the inference result and the indication of the confidence level is based on physical (L1) layer signaling. In some embodiments, the receiving of at least one of the inference result and the indication of the confidence level is based on Media Access Control (MAC) layer signaling. In some embodiments, the receiving of at least one of the inference result and the indication of the confidence level is based on Radio Resource Control (RRC) layer signaling. In some embodiments, the circuitry is further configured to: transmit, based on the decision to synchronize the first machine learning model and the second machine learning model, to the UE an instruction to synchronize the first machine learning model with the second machine learning model. In some embodiments, the synchronizing includes switching from the first machine learning model to another machine learning model that corresponds to the second machine learning model. In some embodiments, the transmitting of the instruction to synchronize the first machine learning model is based on physical layer (L1) signaling. In some embodiments, the transmitting of the instruction to synchronize the first machine learning model is based on Media Access Control (MAC) layer signaling. In some embodiments, the transmitting of the instruction to synchronize the first machine learning model is based on Radio Resource Control (RRC) layer signaling. In some embodiments, the operation of the mobile telecommunications system includes beam management. In some embodiments, the operation of the mobile telecommunications system includes determining channel state information (CSI). In some embodiments, the operation of the mobile telecommunications system includes positioning.

Some embodiments pertain to a circuitry for a mobile telecommunication system, wherein the circuitry is configured to: receive, from a UE of the mobile telecommunications system, an inference result of a first machine learning model and an indication of a confidence level of the inference result, wherein the first machine learning model is executed by the UE for an operation of the mobile telecommunications system; determine a mismatch between the inference result of the first machine learning model and an inference result of a second machine learning model executed by the circuitry for the operation of the mobile telecommunications system; and decide to synchronize the first machine learning model with the second machine learning model based on the confidence level of the inference result of the first machine learning model.

The circuitry may be provided in a network node of a core network of the mobile telecommunications system. For example, the circuitry may communicate with a base station of the mobile telecommunications system via the core network. The circuitry may further communicate with the UE of the mobile telecommunications system, as described above for embodiments with UE-triggered switching and/or with network-triggered switching, via the base station.

Like the circuitry of a network node described above for embodiments with UE-triggered switching and/or for embodiments with network-triggered switching, the circuitry may be configured correspondingly as a network-side counterpart of a UE of an embodiment with two models and may, apart from being provided separately from the base station, be configured correspondingly like the (circuitry of) the base station of the telecommunications system described above. Accordingly, the circuitry may have any features that correspond to features described above with reference to the base station (and/or its circuitry). For example, the circuitry may include a general-purpose computer as described with reference to FIG. 10.

Like the circuitry of a network node described above, the circuitry may include a GPU and/or a TPU for faster and/or more energy efficient training and/or execution of the machine learning model. As described above, the circuitry may train and/or execute the machine learning model for a plurality of base stations, which may have the advantages described above.

In some embodiments, the receiving of at least one of the inference result and the indication of the confidence level is based on physical (L1) layer signaling. In some embodiments, the receiving of at least one of the inference result and the indication of the confidence level is based on Media Access Control (MAC) layer signaling. In some embodiments, the receiving of at least one of the inference result and the indication of the confidence level is based on Radio Resource Control (RRC) layer signaling. In some embodiments, the circuitry is further configured to: transmit, based on the decision to synchronize the first machine learning model and the second machine learning model, to the UE an instruction to synchronize the first machine learning model with the second machine learning model. In some embodiments, the synchronizing includes switching from the first machine learning model to another machine learning model that corresponds to the second machine learning model. In some embodiments, the transmitting of the instruction to synchronize the first machine learning model is based on physical (L1) layer signaling. In some embodiments, the transmitting of the instruction to synchronize the first machine learning model is based on Media Access Control (MAC) layer signaling. In some embodiments, the transmitting of the instruction to synchronize the first machine learning model is based on Radio Resource Control (RRC) layer signaling. In some embodiments, the operation of the mobile telecommunications system includes beam management. In some embodiments, the operation of the mobile telecommunications system includes determining channel state information (CSI). In some embodiments, the operation of the mobile telecommunications system includes positioning.

Some embodiments pertain to a method for a UE of a mobile telecommunication system, wherein the method includes: obtaining an inference result of a first machine learning model for an operation of the mobile telecommunications system, wherein the first machine learning model is executed by the UE; determining a confidence level of the inference result; and transmitting the inference result and an indication of the confidence level to a network of the mobile telecommunications system.

The method may be performed by (the circuitry of) the UE of the mobile telecommunications system described above for embodiments with two models. Accordingly, the method may have features corresponding to any features described above with respect to the UE.

In some embodiments, the transmitting of at least one of the inference result and the indication of the confidence level is based on physical (L1) layer signaling. In some embodiments, the transmitting of at least one of the inference result and the indication of the confidence level is based on Media Access Control (MAC) layer signaling. In some embodiments, the transmitting of at least one of the inference result and the indication of the confidence level is based on Radio Resource Control (RRC) layer signaling. In some embodiments, the method further includes: receiving, in response to the transmitting of the inference result and the indication of the confidence level, from the network an instruction to synchronize the first machine learning model with a second machine learning model executed by the network for the operation of the mobile telecommunications system. In some embodiments, the synchronizing includes switching from the first machine learning model to another machine learning model that corresponds to the second machine learning model. In some embodiments, the receiving of the instruction to synchronize the first machine learning model is based on physical (L1) layer signaling. In some embodiments, the receiving of the instruction to synchronize the first machine learning model is based on Media Access Control (MAC) layer signaling. In some embodiments, the receiving of the instruction to synchronize the first machine learning model is based on Radio Resource Control (RRC) layer signaling. In some embodiments, the operation of the mobile telecommunications system includes beam management. In some embodiments, the operation of the mobile telecommunications system includes determining channel state information (CSI). In some embodiments, the operation of the mobile telecommunications system includes positioning.

Some embodiments pertain to a method for a mobile telecommunication system, wherein the method includes: receiving, from a UE of the mobile telecommunications system, an inference result of a first machine learning model and an indication of a confidence level of the inference result, wherein the first machine learning model is executed by the UE for an operation of the mobile telecommunications system; determining a mismatch between the inference result of the first machine learning model and an inference result of a second machine learning model executed by a network node of the mobile telecommunications system for the operation of the mobile telecommunications system; and deciding to synchronize the first machine learning model with the second machine learning model based on the confidence level of the inference result of the first machine learning model.

The method may be performed by (the circuitry of) the base station and/or the circuitry (of a network node in the core network) described above for embodiments with two models. Accordingly, the method may have features corresponding to any features described above with respect to the base station and/or to the circuitry of the network node.

In some embodiments, the receiving of at least one of the inference result and the indication of the confidence level is based on physical (L1) layer signaling. In some embodiments, the receiving of at least one of the inference result and the indication of the confidence level is based on Media Access Control (MAC) layer signaling. In some embodiments, the receiving of at least one of the inference result and the indication of the confidence level is based on Radio Resource Control (RRC) layer signaling. In some embodiments, the method further includes: transmitting, based on the decision to synchronize the first machine learning model and the second machine learning model, to the UE an instruction to synchronize the first machine learning model with the second machine learning model. In some embodiments, the synchronizing includes switching from the first machine learning model to another machine learning model that corresponds to the second machine learning model. In some embodiments, the transmitting of the instruction to synchronize the first machine learning model is based on physical (L1) layer signaling. In some embodiments, the transmitting of the instruction to synchronize the first machine learning model is based on Media Access Control (MAC) layer signaling. In some embodiments, the transmitting of the instruction to synchronize the first machine learning model is based on Radio Resource Control (RRC) layer signaling. In some embodiments, the operation of the mobile telecommunications system includes beam management. In some embodiments, the operation of the mobile telecommunications system includes determining channel state information (CSI). In some embodiments, the operation of the mobile telecommunications system includes positioning.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

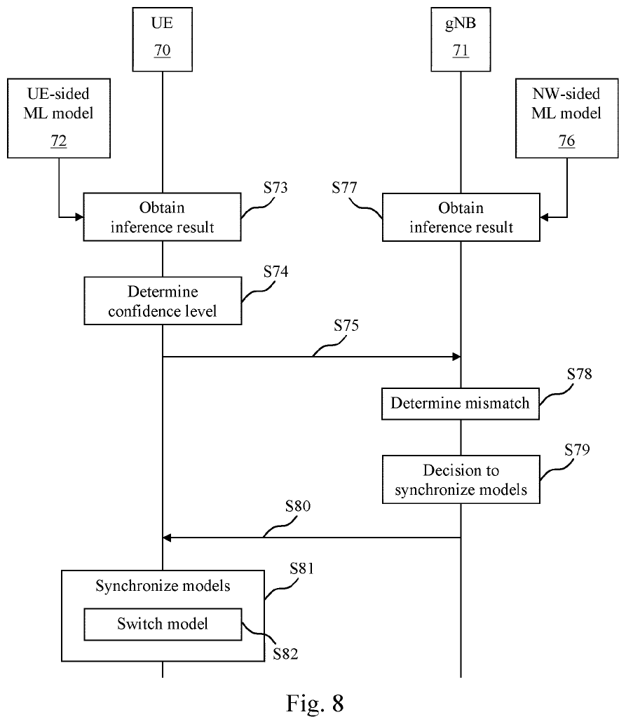

FIG. 8 illustrates a method according to an embodiment with two models. The method is performed by a UE 70 and a gNB 71 of a mobile telecommunications system. The UE 3 of FIG. 1 is an example of the UE 70, the gNB 2 of FIG. 1 is an example of the gNB 71, and the mobile telecommunications system 1 of FIG. 1 is an example of the mobile telecommunications system in which the UE 70 and the gNB 71 are included.

The UE 70 executes a UE-sided ML model 72 for beam management and, at S73, obtains an inference result of the UE-sided ML model 72.

At S74, the UE 70 determines a confidence level of the inference result obtained at S73.

At S75, the UE 70 transmits, via RRC layer signaling, to the gNB 71 the inference result obtained at S73 and an indication of the confidence level determined at S74. The gNB 71 receives the inference result obtained at S73 and the indication of the confidence level.

The gNB 71 executes a NW-sided ML model 76 for beam management and, at S77, obtains an inference result of the NW-sided ML model 76.

At S78, the gNB 71 determines a mismatch between the inference result of the UE-sided ML model 72 and the inference result of the NW-sided ML model 76.

At S79, the gNB 71 decides to synchronize the UE-sided ML model 72 with the NW-sided ML model 76 based on the confidence level of the inference result of the UE-sided ML model 72.

At S80, the gNB 71 transmits, based on RRC layer signaling, and based on the decision at S79 to synchronize, to the UE 70 an instruction to synchronize the UE-sided ML model 72 with the NW-sided ML model 76. The UE 70 receives the instruction at S80 in response to the transmitting at S75.

At S81, the UE 70 synchronizes the UE-sided ML model 72 with the NW-sided ML model 76 according to the instruction at S80. The synchronizing at S82 includes switching, at S82, from the UE-sided ML model 72 to another ML model for beam management that corresponds to the NW-sided ML model 76. The switching at S82 includes deactivating the UE-sided ML model 72 and activating the other ML model. The other ML model is a UE-sided ML model and is executed by the UE 70.

It is noted that the UE-sided ML model 72, the NW-sided ML model 76 and the other (UE-sided) ML model may as well be executed for determining CSI and/or for positioning. It is also noted that the transmitting at S75 and/or S80 may as well be based on MAC layer signaling and/or on L1 layer signaling. It is further noted that the obtaining of an inference result at S77 is performed before the obtaining of an inference result at S73 in some embodiments, and that the obtaining of an inference result at S73, the determining of the confidence level at S74 and/or the transmitting at S75 is performed before the obtaining of an inference result at S77 in some embodiments. Finally, it is noted that, in some embodiments, the method is performed by the UE 70 and, instead of the gNB 71, a network node of a core network (e.g., the core network 4 of FIG. 1) of the mobile telecommunications system

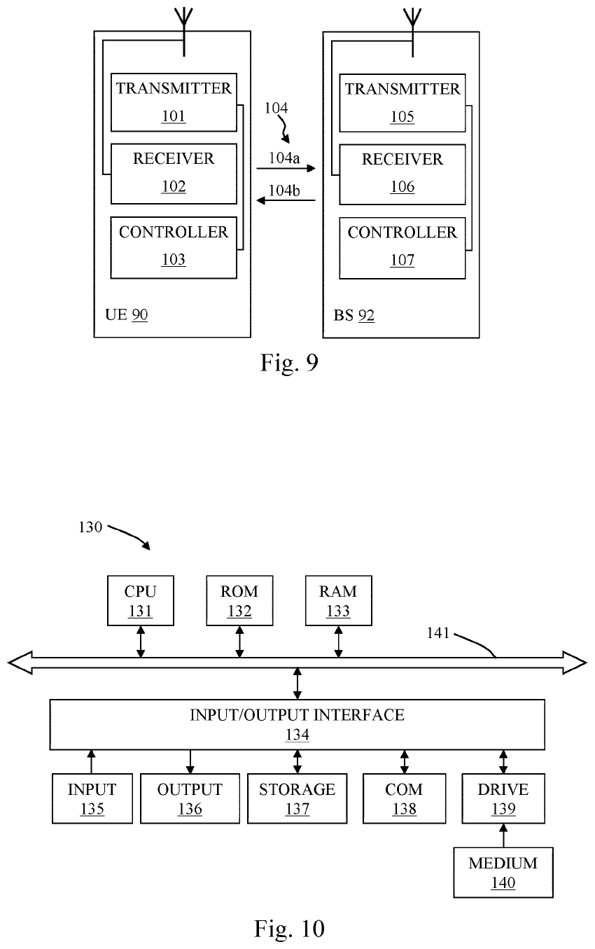

FIG. 9 illustrates a user equipment (UE) and a base station (BS) according to an embodiment.

An embodiment of a UE 90 according to the present disclosure (e.g., the UE 3 of FIG. 1, the UE 10 of FIG. 2, the UE 20 of FIG. 3, the UE 30 of FIG. 4, the UE 40 of FIG. 5, the UE 50 of FIG. 6, the UE 60 of FIG. 7 or the UE 70 of FIG. 8), a base station (BS) 92 according to the present disclosure (e.g., NR gNB such as the gNB 2 of FIG. 1, the gNB 11 of FIG. 2, the gNB 21 of FIG. 3, the gNB 31 of FIG. 4, the gNB 41 of FIG. 5, the gNB 51 of FIG. 6, the gNB 61 of FIG. 7 or the gNB 71 of FIG. 8), and a communication path 104 between the UE 90 and the BS 92, which are used for implementing embodiments of the present disclosure, is discussed under reference of FIG. 9.

The UE 90 has a transmitter 101, a receiver 102 and a controller 103, wherein, generally, the technical functionality of the transmitter 101, the receiver 102 and the controller 103 are known to the skilled person, and, thus, a more detailed description of these elements is omitted.

The BS 92 has a transmitter 105, a receiver 106 and a controller 107, wherein, generally, the technical functionality of the transmitter 105, the receiver 106 and the controller 107 are known to the skilled person, and, thus, a more detailed description of these elements is omitted.

The communication path 104 has an uplink path 104a, which is from the UE 90 to the BS 92, and a downlink path 104b, which is from the BS 92 to the UE 90. The communication path 104 includes an access link according to the present disclosure.

During operation, the controller 103 of the UE 90 controls the reception of downlink signals over the downlink path 104b at the receiver 102 and the controller 103 controls the transmission of uplink signals over the uplink path 104a via the transmitter 101.

Similarly, during operation, the controller 107 of the BS 92 controls the reception of uplink signals over the uplink path 104a and the controller 107 controls the transmission of downlink signals over the downlink path 104b.

In the following, an embodiment of a general-purpose computer 130 is described under reference of FIG. 10, which illustrates a general-purpose computer according to an embodiment.

The computer 130 can be implemented such that it can basically function as any type of user equipment, base station or new radio base station, transmission and reception point, or network node, as discussed herein. For example, the computer 130 can be configured to perform corresponding processing of the methods of FIG. 3 to FIG. 8 as a circuitry of a user equipment, of a base station and/or of a core network node.

The computer 130 has components 131 to 141, which can form circuitry, such as any one of the circuitries of the base station, network node and user equipment, and the like, as described herein.

Embodiments which use software, firmware, programs or the like for performing the methods as described herein can be installed on computer 130, which is then configured to be suitable for the particular embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random-access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station, network node or user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, electronic ink, etc.), loudspeakers, etc.

The storage 137 can have a hard disk, a solid-state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, near-field communication (NFC), etc.

It should be noted that the description above only pertains to an example configuration of computer 130. Alternative configurations may be implemented with additional or other sensors, storage devices, interfaces or the like. For example, the communication interface 138 may support other radio access technologies than UMTS, LTE and NR, or the like.

When the computer 130 functions as a base station, the communication interface 138 can further have a respective air interface (providing, e.g., E-UTRA protocols OFDMA (downlink) and SC-FDMA (uplink)) and network interfaces (implementing for example protocols such as S1-AP, GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

It should be recognized that the embodiments describe methods with an exemplary ordering of method steps. The specific ordering of method steps is however given for illustrative purposes only and should not be construed as binding. For example, method steps may be exchanged, as described above. Other changes of the ordering of method steps may be apparent to the skilled person.

Please note that the division of the UE 90 into units 101 to 103 and the division of the BS 92 into units 105 to 107 is only made for illustration purposes and that the present disclosure is not limited to any specific division of functions in specific units. For instance, the UE 90 and/or the BS 92 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(A1) A user equipment for a mobile telecommunications system, the user equipment comprising circuitry configured to:
   obtain performance information indicating a performance of a first machine learning model for an operation of the mobile telecommunications system;
   decide, based on the performance information, to switch to another machine learning model for the operation of the mobile telecommunications system; and
   transmit to a network of the mobile telecommunications system an indication of the decision to switch.
(A2) the user equipment of (A1),
   wherein the decision to switch to another machine learning model includes determining, based on the performance information, that the performance of the first machine learning model satisfies a switching condition configured by the network for switching to another machine learning model for the operation of the mobile telecommunications system.
(A3) The user equipment of (A1) or (A2),
   wherein the circuitry is further configured to switch, according to the decision to switch to another machine learning model, to a second machine learning model and execute an inference of the second machine learning model; and
   wherein the transmitting of the indication of the decision to switch to another machine learning model includes reporting the switching to the second machine learning model to the network.
(A4) the user equipment of (A1) or (A2),
wherein the indication of the decision to switch to another machine learning model includes a request to switch to another machine learning model for the operation of the mobile telecommunications system.
(A5) The user equipment of any one of (A1) to (A4),
   wherein the operation of the mobile telecommunications system includes beam management.
(A6) The user equipment of any one of (A1) to (A5),
   wherein the operation of the mobile telecommunications system includes determining channel state information.
(A7) The user equipment of any one of (A1) to (A6),
   wherein the operation of the mobile telecommunications system includes positioning.
(A8) The user equipment of any one of (A1) to (A7),
   wherein the transmitting of the indication of the decision to switch to another machine learning model is based on physical layer signaling.
(A9) The user equipment of any one of (A1) to (A7),
   wherein the transmitting of the indication of the decision to switch to another machine learning model is based on Media Access Control layer signaling.
(A10) The user equipment of any one of (A1) to (A7),
   wherein the transmitting of the indication of the decision to switch to another machine learning model is based on Radio Resource Control layer signaling.
(A11) The user equipment of any one of (A1) to (A10),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(A12) The user equipment of any one of (A1) to (A11),
   wherein the decision to switch to another machine learning model includes a decision of a type of the other machine learning model; and
   wherein the indication of the decision to switch to another machine learning model indicates the type of the other machine learning model.
(A13) The user equipment of any one of (A1) to (A12),
   wherein the decision to switch to another machine learning model includes selecting a second machine learning model for switching; and
   wherein the indication of the decision to switch identifies the selected second machine learning model.
(A14) The user equipment of any one of (A1) to (A12),
   wherein the indication of the decision to switch includes a selection request to select another machine learning model for switching; and
   wherein the circuitry is further configured to receive from the network an indication of a selected second machine learning model for switching.
(B1) A base station for a mobile telecommunications system, the base station comprising circuitry configured to:
   receive from a user equipment of the mobile telecommunications system an indication of a decision to switch from a first machine learning model for an operation of the mobile telecommunications system to another machine learning model for the operation of the mobile telecommunications system.
(B2) The base station of (B1),
   wherein the circuitry is further configured to configure a switching condition for switching to another machine learning model for the operation of the mobile telecommunications system.
(B3) The base station of (B1) or (B2),
   wherein the receiving of the indication of the decision to switch to another machine learning model includes receiving a report that the user equipment has switched to the second machine learning model.
(B4) The base station of (B1) or (B2),
   wherein the indication of the decision to switch to another machine learning model includes a request to switch to another machine learning model for the operation of the mobile telecommunications system; and
   wherein the circuitry is further configured to switch to a second machine learning model according to the request.
(B5) The base station of any one of (B1) to (B4),
   wherein the operation of the mobile telecommunications system includes beam management.
(B6) The base station of any one of (B1) to (B5),
   wherein the operation of the mobile telecommunications system includes determining channel state information.
(B7) The base station of any one of (B1) to (B6),
   wherein the operation of the mobile telecommunications system includes positioning.
(B8) The base station of any one of (B1) to (B7),
   wherein the receiving of the indication of the decision to switch to another machine learning model is based on physical layer signaling.
(B9) The base station of any one of (B1) to (B7),
   wherein the receiving of the indication of the decision to switch to another machine learning model is based on Media Access Control layer signaling.
(B10) The base station of any one of (B1) to (B7),
   wherein the receiving of the indication of the decision to switch to another machine learning model is based on Radio Resource Control layer signaling.
(B11) The base station of any one of (B1) to (B10),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(B12) The base station of any one of (B1) to (B11),
   wherein the decision to switch to another machine learning model includes a decision of a type of the other machine learning model; and
   wherein the indication of the decision to switch to another machine learning model indicates the type of the other machine learning model.
(B13) The base station of any one of (B1) to (B12),
   wherein the decision to switch to another machine learning model includes selecting a second machine learning model for switching; and
   wherein the indication of the decision to switch identifies the selected second machine learning model.
(B14) The base station of any one of (B1) to (B12),
   wherein the indication of the decision to switch includes a selection request to select another machine learning model for switching; and
   wherein the circuitry is further configured to:
      select a second machine learning model for switching according to the selection request; and
      transmit to the user equipment an indication of the selected second machine learning model.
(C1) A circuitry for a mobile telecommunications system, the circuitry being configured to:
   receive from a user equipment of the mobile telecommunications system an indication of a decision to switch from a first machine learning model for an operation of the mobile telecommunications system to another machine learning model for the operation of the mobile telecommunications system.
(C2) the circuitry of (C1),
   wherein the circuitry is further configured to configure a switching condition for switching to another machine learning model for the operation of the mobile telecommunications system.
(C3) The circuitry of (C1) or (C2),
   wherein the receiving of the indication of the decision to switch to another machine learning model includes receiving a report that the user equipment has switched to the second machine learning model.
(C4) the circuitry of (C1) or (C2),
   wherein the indication of the decision to switch to another machine learning model includes a request to switch to another machine learning model for the operation of the mobile telecommunications system; and
   wherein the circuitry is further configured to switch to a second machine learning model according to the request.
(C5) The circuitry of any one of (C1) to (C4),
   wherein the operation of the mobile telecommunications system includes beam management.
(C6) The circuitry of any one of (C1) to (C5),
   wherein the operation of the mobile telecommunications system includes determining channel state information.
(C7) The circuitry of any one of (C1) to (C6),
   wherein the operation of the mobile telecommunications system includes positioning.
(C8) The circuitry of any one of (C1) to (C7),
   wherein the receiving of the indication of the decision to switch to another machine learning model is based on physical layer signaling.
(C9) The circuitry of any one of (C1) to (C7),
   wherein the receiving of the indication of the decision to switch to another machine learning model is based on Media Access Control layer signaling.
(C10) The circuitry of any one of (C1) to (C7),
   wherein the receiving of the indication of the decision to switch to another machine learning model is based on Radio Resource Control layer signaling.
(C11) The circuitry of any one of (C1) to (C10),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(C12) The circuitry of any one of (C1) to (C11),
   wherein the decision to switch to another machine learning model includes a decision of a type of the other machine learning model; and
   wherein the indication of the decision to switch to another machine learning model indicates the type of the other machine learning model.
(C13) The circuitry of any one of (C1) to (C12),
   wherein the decision to switch to another machine learning model includes selecting a second machine learning model for switching; and
   wherein the indication of the decision to switch identifies the selected second machine learning model.
(C14) The circuitry of any one of (C1) to (C12),
   wherein the indication of the decision to switch includes a selection request to select another machine learning model for switching; and
   wherein the circuitry is further configured to:
      select a second machine learning model for switching according to the selection request; and
      transmit to the user equipment an indication of the selected second machine learning model.
(D1) A method for a user equipment of a mobile telecommunications system, the method comprising:
   obtaining performance information indicating a performance of a first machine learning model for an operation of the mobile telecommunications system;
   deciding, based on the performance information, to switch to another machine learning model for the operation of the mobile telecommunication system; and
   transmitting to a network of the mobile telecommunications system an indication of the decision to switch.
(D2) The method of (D1),
   wherein the decision to switch to another machine learning model includes determining, based on the performance information, that the performance of the first machine learning model satisfies a switching condition configured by the network for switching to another machine learning model for the operation of the mobile telecommunications system.
(D3) The method of (D1) or (D2),
   wherein the method further comprises switching, according to the decision to switch to another machine learning model, to a second machine learning model and executing an inference of the second machine learning model; and
   wherein the transmitting of the indication of the decision to switch to another machine learning model includes reporting the switching to the second machine learning model to the network.
(D4) The method of (D1) or (D2),
   wherein the indication of the decision to switch to another machine learning model includes a request to switch to another machine learning model for the operation of the mobile telecommunications system.
(D5) The method of any one of (D1) to (D4),
   wherein the operation of the mobile telecommunications system includes beam management.
(D6) The method of any one of (D1) to (D5),
   wherein the operation of the mobile telecommunications system includes determining channel state information.
(D7) The method of any one of (D1) to (D6),
   wherein the operation of the mobile telecommunications system includes positioning.
(D8) The method of any one of (D1) to (D7),
   wherein the transmitting of the indication of the decision to switch to another machine learning model is based on physical layer signaling.
(D9) The method of any one of (D1) to (D7),
   wherein the transmitting of the indication of the decision to switch to another machine learning model is based on Media Access Control layer signaling.
(D10) The method of any one of (D1) to (D7),
   wherein the transmitting of the indication of the decision to switch to another machine learning model is based on Radio Resource Control layer signaling.
(D11) The method of any one of (D1) to (D10),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(D12) The method of any one of (D1) to (D11),
   wherein the decision to switch to another machine learning model includes a decision of a type of the other machine learning model; and
   wherein the indication of the decision to switch to another machine learning model indicates the type of the other machine learning model.
(D13) The method of any one of (D1) to (D12),
   wherein the decision to switch to another machine learning model includes selecting a second machine learning model for switching; and
   wherein the indication of the decision to switch identifies the selected second machine learning model.
(D14) The method of any one of (D1) to (D12),
   wherein the indication of the decision to switch includes a selection request to select another machine learning model for switching; and
   wherein the method further includes receiving from the network an indication of a selected second machine learning model for switching.
(E1) A method for a mobile telecommunications system, the method comprising:
   receiving from a user equipment of the mobile telecommunications system an indication of a decision to switch from a first machine learning model for an operation of the mobile telecommunications system to another machine learning model for the operation of the mobile telecommunications system.
(E2) The method of (E1),
   wherein the method further comprises configuring a switching condition for switching to another machine learning model for the operation of the mobile telecommunications system.
(E3) The method of (E1) or (E2),
   wherein the receiving of the indication of the decision to switch to another machine learning model includes receiving a report that the user equipment has switched to the second machine learning model.
(E4) The method of (E1) or (E2),
   wherein the indication of the decision to switch to another machine learning model includes a request to switch to another machine learning model for the operation of the mobile telecommunications system; and
   wherein the method further comprises switching to a second machine learning model according to the request.
(E5) The method of any one of (E1) to (E4),
   wherein the operation of the mobile telecommunications system includes beam management.
(E6) The method of any one of (E1) to (E5),
   wherein the operation of the mobile telecommunications system includes determining channel state information.
(E7) The method of any one of (E1) to (E6),
   wherein the operation of the mobile telecommunications system includes positioning.
(E8) The method of any one of (E1) to (E7),
   wherein the receiving of the indication of the decision to switch to another machine learning model is based on physical layer signaling.
(E9) The method of any one of (E1) to (E7),
   wherein the receiving of the indication of the decision to switch to another machine learning model is based on Media Access Control layer signaling.
(E10) The method of any one of (E1) to (E7),
   wherein the receiving of the indication of the decision to switch to another machine learning model is based on Radio Resource Control layer signaling.
(E11) The method of any one of (E1) to (E10),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(E12) The method of any one of (E1) to (E11),
   wherein the decision to switch to another machine learning model includes a decision of a type of the other machine learning model; and
   wherein the indication of the decision to switch to another machine learning model indicates the type of the other machine learning model.
(E13) The method of any one of (E1) to (E12),
   wherein the decision to switch to another machine learning model includes selecting a second machine learning model for switching; and
   wherein the indication of the decision to switch identifies the selected second machine learning model.
(E14) The method of any one of (E1) to (E12),
   wherein the indication of the decision to switch includes a selection request to select another machine learning model for switching; and
   wherein the method further comprises:
      selecting a second machine learning model for switching according to the selection request; and
      transmitting to the user equipment an indication of the selected second machine learning model.
(F1) A computer program comprising program code causing a computer to perform the method according to anyone of (D1) to (E14), when being carried out on a computer.
(F2) A non-transitory computer-readable recording medium that stores therein a computer program product, which, when executed by a processor, causes the method according to anyone of (D1) to (E14) to be performed.
(G1) A user equipment for a mobile telecommunications system, the user equipment comprising circuitry configured to:
   receive from a network of the mobile telecommunications system an indication of a decision to switch from a first machine learning model for an operation of the mobile telecommunications system to another machine learning model for the operation of the mobile telecommunications system.
(G2) The user equipment of (G1),
   wherein the receiving of the indication of the decision to switch to another machine learning model includes receiving a report that the network has switched to the second machine learning model.
(G3) The user equipment of (G1) or (G2),
   wherein the indication of the decision to switch to another machine learning model includes an instruction to switch to another machine learning model for the operation of the mobile telecommunications system; and
   wherein the circuitry is further configured to switch to a second machine learning model according to the instruction.
(G4) The user equipment of any one of (G1) to (G3),
   wherein the operation of the mobile telecommunications system includes beam management.
(G5) The user equipment of any one of (G1) to (G4),
   wherein the operation of the mobile telecommunications system includes determining channel state information.
(G6) The user equipment of any one of (G1) to (G5),
   wherein the operation of the mobile telecommunications system includes positioning.
(G7) The user equipment of any one of (G1) to (G6),
   wherein the receiving of the indication of the decision to switch to another machine learning model is based on physical layer signaling.
(G8) The user equipment of any one of (G1) to (G6),
   wherein the receiving of the indication of the decision to switch to another machine learning model is based on Media Access Control layer signaling.
(G9) The user equipment of any one of (G1) to (G8),
   wherein the receiving of the indication of the decision to switch to another machine learning model is based on Radio Resource Control layer signaling.
(G10) The user equipment of any one of (G1) to (G9),
   wherein the decision to switch to another machine learning model includes a decision to switch to a second machine learning model for the operation of the mobile telecommunications system; and wherein the indication of the decision to switch to another machine learning model indicates an identifier of the second machine learning model.
(G11) The user equipment of any one of (G1) to (G10),
   wherein the decision to switch to another machine learning model includes a decision of a type of the other machine learning model; and
   wherein the indication of the decision to switch to another machine learning model indicates the type of the other machine learning model.
(H1) A base station for a mobile telecommunications system, the base station comprising circuitry configured to:
   obtain performance information indicating a performance of a first machine learning model for an operation of the mobile telecommunications system;
   decide, based on the performance information, to switch to another machine learning model for the operation of the mobile telecommunications system; and
   transmit to a user equipment of the mobile telecommunications system an indication of the decision to switch.
(H2) The base station of (H1),
   wherein the circuitry is further configured to switch, according to the decision to switch to another machine learning model, to a second machine learning model and execute an inference of the second machine learning model; and
   wherein the transmitting of the indication of the decision to switch to another machine learning model includes reporting the switching to the second machine learning model to the user equipment.
(H3) The base station of (H1) or (H2),
   wherein the indication of the decision to switch to another machine learning model includes an instruction to switch to another machine learning model for the operation of the mobile telecommunications system.
(H4) The base station of any one of (H1) to (H3),
   wherein the operation of the mobile telecommunications system includes beam management.
(H5) The base station of any one of (H1) to (H4),
   wherein the operation of the mobile telecommunications system includes determining channel state information.
(H6) The base station of any one of (H1) to (H5),
   wherein the operation of the mobile telecommunications system includes positioning.
(H7) The base station of any one of (H1) to (H6),
   wherein the transmitting of the indication of the decision to switch to another machine learning model is based on physical layer signaling.
(H8) The base station of any one of (H1) to (H6),
   wherein the transmitting of the indication of the decision to switch to another machine learning model is based on Media Access Control layer signaling.
(H9) The base station of any one of (H1) to (H6),
   wherein the transmitting of the indication of the decision to switch to another machine learning model is based on Radio Resource Control layer signaling.
(H10) The base station of any one of (H1) to (H9),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(H11) The base station of any one of (H1) to (H10),
   wherein the decision to switch to another machine learning model includes a decision of a type of the other machine learning model; and
   wherein the indication of the decision to switch to another machine learning model indicates the type of the other machine learning model.
(I1) A circuitry for a mobile telecommunications system, the circuitry being configured to:
   obtain performance information indicating a performance of a first machine learning model for an operation of the mobile telecommunications system;
   decide, based on the performance information, to switch to another machine learning model for the operation of the mobile telecommunications system; and
   transmit to a user equipment of the mobile telecommunications system an indication of the decision to switch.
(I2) The circuitry of (I1),
   wherein the circuitry is further configured to switch, according to the decision to switch to another machine learning model, to a second machine learning model and execute an inference of the second machine learning model; and
   wherein the transmitting of the indication of the decision to switch to another machine learning model includes reporting the switching to the second machine learning model to the user equipment.
(I3) The circuitry of (I1) or (I2),
   wherein the indication of the decision to switch to another machine learning model includes an instruction to switch to another machine learning model for the operation of the mobile telecommunications system.
(I4) The circuitry of any one of (I1) to (I3),
   wherein the operation of the mobile telecommunications system includes beam management.
(I5) The circuitry of any one of (I1) to (I4),
   wherein the operation of the mobile telecommunications system includes determining channel state information.
(I6) The circuitry of any one of (I1) to (I5),
   wherein the operation of the mobile telecommunications system includes positioning.
(I7) The circuitry of any one of (I1) to (I6),
   wherein the transmitting of the indication of the decision to switch to another machine learning model is based on physical layer signaling.
(I8) The circuitry of any one of (I1) to (I6),
   wherein the transmitting of the indication of the decision to switch to another machine learning model is based on Media Access Control layer signaling.
(I9) The circuitry of any one of (I1) to (I6),
   wherein the transmitting of the indication of the decision to switch to another machine learning model is based on Radio Resource Control layer signaling.
(I10) The circuitry of any one of (I1) to (I9),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(I11) The circuitry of any one of (I1) to (I10),
   wherein the decision to switch to another machine learning model includes a decision of a type of the other machine learning model; and
   wherein the indication of the decision to switch to another machine learning model indicates the type of the other machine learning model.
(J1) A method for a user equipment of a mobile telecommunications system, the method comprising:
   receiving from a network of the mobile telecommunications system an indication of a decision to switch from a first machine learning model for an operation of the mobile telecommunications system to another machine learning model for the operation of the mobile telecommunications system.
(J2) The method of (J1),
   wherein the receiving of the indication of the decision to switch to another machine learning model includes receiving a report that the network has switched to the second machine learning model.
(J3) The method of (J1) or (J2),
   wherein the indication of the decision to switch to another machine learning model includes an instruction to switch to another machine learning model for the operation of the mobile telecommunications system; and
   wherein the method further comprises switching to a second machine learning model according to the instruction.
(J4) The method of any one of (J1) to (J3),
   wherein the operation of the mobile telecommunications system includes beam management.
(J5) The method of any one of (J1) to (J4),
   wherein the operation of the mobile telecommunications system includes determining channel state information.
(J6) The method of any one of (J1) to (J5),
   wherein the operation of the mobile telecommunications system includes positioning.
(J7) The method of any one of (J1) to (J6),
   wherein the receiving of the indication of the decision to switch to another machine learning model is based on physical layer signaling.
(J8) The method of any one of (J1) to (J6),
   wherein the receiving of the indication of the decision to switch to another machine learning model is based on Media Access Control layer signaling.
(J9) The method of any one of (J1) to (J8),
   wherein the receiving of the indication of the decision to switch to another machine learning model is based on Radio Resource Control layer signaling.
(J10) The method of any one of (J1) to (J9),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(J11) The method of any one of (J1) to (J10),
   wherein the decision to switch to another machine learning model includes a decision of a type of the other machine learning model; and
   wherein the indication of the decision to switch to another machine learning model indicates the type of the other machine learning model.
(K1) A method for a mobile telecommunications system, the method comprising:
   obtaining performance information indicating a performance of a first machine learning model for an operation of the mobile telecommunications system;
   deciding, based on the performance information, to switch to another machine learning model for the operation of the mobile telecommunications system; and
   transmitting to a user equipment of the mobile telecommunications system an indication of the decision to switch.
(K2) The method of (K1),
   wherein the method further comprises switching, according to the decision to switch to another machine learning model, to a second machine learning model and execute an inference of the second machine learning model; and
   wherein the transmitting of the indication of the decision to switch to another machine learning model includes reporting the switching to the second machine learning model to the user equipment.
(K3) The method of (K1) or (K2),
   wherein the indication of the decision to switch to another machine learning model includes an instruction to switch to another machine learning model for the operation of the mobile telecommunications system.
(K4) The method of any one of (K1) to (K3),
   wherein the operation of the mobile telecommunications system includes beam management.
(K5) The method of any one of (K1) to (K4),
   wherein the operation of the mobile telecommunications system includes determining channel state information.
(K6) The method of any one of (K1) to (K5),
   wherein the operation of the mobile telecommunications system includes positioning.
(K7) The method of any one of (K1) to (K6),
   wherein the transmitting of the indication of the decision to switch to another machine learning model is based on physical layer signaling.
(K8) The method of any one of (K1) to (K6),
   wherein the transmitting of the indication of the decision to switch to another machine learning model is based on Media Access Control layer signaling.
(K9) The method of any one of (K1) to (K6),
   wherein the transmitting of the indication of the decision to switch to another machine learning model is based on Radio Resource Control layer signaling.
(K10) The method of any one of (K1) to (K9),
   wherein the decision to switch to another machine learning model includes a decision to switch to a second machine learning model for the operation of the mobile telecommunications system; and
   wherein the indication of the decision to switch to another machine learning model indicates an identifier of the second machine learning model.
(K11) The method of any one of (K1) to (K10),
   wherein the decision to switch to another machine learning model includes a decision of a type of the other machine learning model; and
   wherein the indication of the decision to switch to another machine learning model indicates the type of the other machine learning model.
(L1) A computer program comprising program code causing a computer to perform the
   method according to anyone of (J1) to (K11), when being carried out on a computer.
(L2) A non-transitory computer-readable recording medium that stores therein a computer program product, which, when executed by a processor, causes the method according to anyone of (J1) to (K11) to be performed.
(M1) A user equipment for a mobile telecommunication system, the user equipment comprising circuitry configured to:
   obtain an inference result of a first machine learning model for an operation of the mobile telecommunications system, wherein the first machine learning model is executed by the user equipment;
   determine a confidence level of the inference result; and
   transmit the inference result and an indication of the confidence level to a network of the mobile telecommunications system.
(M2) The user equipment of (M1),
   wherein the transmitting of at least one of the inference result and the indication of the confidence level is based on physical layer signaling.
(M3) The user equipment of (M1),
   wherein the transmitting of at least one of the inference result and the indication of the confidence level is based on Media Access Control layer signaling.
(M4) The user equipment of (M1),
   wherein the transmitting of at least one of the inference result and the indication of the confidence level is based on Radio Resource Control layer signaling.
(M5) The user equipment of any one of (M1) to (M4), wherein the circuitry is further configured to:
   receive, in response to the transmitting of the inference result and the indication of the confidence level, from the network an instruction to synchronize the first machine learning model with a second machine learning model executed by the network for the operation of the mobile telecommunications system.
(M6) The user equipment of (M5),
   wherein the synchronizing includes switching from the first machine learning model to another machine learning model that corresponds to the second machine learning model.
(M7) The user equipment of (M5) or (M6),
   wherein the receiving of the instruction to synchronize the first machine learning model is based on physical layer signaling.
(M8) The user equipment of (M5) or (M6),
   wherein the receiving of the instruction to synchronize the first machine learning model is based on Media Access Control layer signaling.
(M9) The user equipment of (M5) or (M6),
   wherein the receiving of the instruction to synchronize the first machine learning model is based on Radio Resource Control layer signaling.
(M10) The user equipment of any one of (M1) to (M9),
   wherein the operation of the mobile telecommunications system includes beam management.
(M11) The user equipment of any one of (M1) to (M10),
   wherein the operation of the mobile telecommunications system includes determining channel state information.
(M12) The user equipment of any one of (M1) to (M11),
   wherein the operation of the mobile telecommunications system includes positioning.
(N1) A base station for a mobile telecommunication system, the base station comprising circuitry configured to:
   receive, from a user equipment of the mobile telecommunications system, an inference result of a first machine learning model and an indication of a confidence level of the inference result, wherein the first machine learning model is executed by the user equipment for an operation of the mobile telecommunications system;
   determine a mismatch between the inference result of the first machine learning model and an inference result of a second machine learning model executed by the base station for the operation of the mobile telecommunications system; and
   decide to synchronize the first machine learning model with the second machine learning model based on the confidence level of the inference result of the first machine learning model.
(N2) The base station of (N1),
   wherein the receiving of at least one of the inference result and the indication of the confidence level is based on physical layer signaling.
(N3) The base station of (N1),
   wherein the receiving of at least one of the inference result and the indication of the confidence level is based on Media Access Control layer signaling.
(N4) The base station of (N1),
   wherein the receiving of at least one of the inference result and the indication of the confidence level is based on Radio Resource Control layer signaling.
(N5) The base station of any one of (N1) to (N4), wherein the circuitry is further configured to:
   transmit, based on the decision to synchronize the first machine learning model and the second machine learning model, to the user equipment an instruction to synchronize the first machine learning model with the second machine learning model.
(N6) The base station of (N5),
   wherein the synchronizing includes switching from the first machine learning model to another machine learning model that corresponds to the second machine learning model.
(N7) The base station of (N5) or (N6),
   wherein the transmitting of the instruction to synchronize the first machine learning model is based on physical layer signaling.
(N8) The base station of (N5) or (N6),
   wherein the transmitting of the instruction to synchronize the first machine learning model is based on Media Access Control layer signaling.
(N9) The base station of (N5) or (N6),
   wherein the transmitting of the instruction to synchronize the first machine learning model is based on Radio Resource Control layer signaling.
(N10) The base station of any one of (N1) to (N9),
   wherein the operation of the mobile telecommunications system includes beam management.
(N11) The base station of any one of (N1) to (N10),
   wherein the operation of the mobile telecommunications system includes determining channel state information.
(N12) The base station of any one of (N1) to (N11),
   wherein the operation of the mobile telecommunications system includes positioning.
(O1) A circuitry for a mobile telecommunication system, the circuitry being configured to:
   receive, from a user equipment of the mobile telecommunications system, an inference result of a first machine learning model and an indication of a confidence level of the inference result, wherein the first machine learning model is executed by the user equipment for an operation of the mobile telecommunications system;
   determine a mismatch between the inference result of the first machine learning model and an inference result of a second machine learning model executed by the circuitry for the operation of the mobile telecommunications system; and
   decide to synchronize the first machine learning model with the second machine learning model based on the confidence level of the inference result of the first machine learning model.
(O2) The circuitry of (O1),
   wherein the receiving of at least one of the inference result and the indication of the confidence level is based on physical layer signaling.
(O3) The circuitry of (O1),
   wherein the receiving of at least one of the inference result and the indication of the confidence level is based on Media Access Control layer signaling.
(O4) The circuitry of (O1),
   wherein the receiving of at least one of the inference result and the indication of the confidence level is based on Radio Resource Control layer signaling.
(O5) The circuitry of any one of (O1) to (O4), wherein the circuitry is further configured to:
   transmit, based on the decision to synchronize the first machine learning model and the second machine learning model, to the user equipment an instruction to synchronize the first machine learning model with the second machine learning model.
(O6) The circuitry of (O5),
   wherein the synchronizing includes switching from the first machine learning model to another machine learning model that corresponds to the second machine learning model.
(O7) The circuitry of (O5) or (O6),
   wherein the transmitting of the instruction to synchronize the first machine learning model is based on physical layer signaling.
(O8) The circuitry of (O5) or (O6),
   wherein the transmitting of the instruction to synchronize the first machine learning model is based on Media Access Control layer signaling.
(O9) The circuitry of (O5) or (O6),
   wherein the transmitting of the instruction to synchronize the first machine learning model is based on Radio Resource Control layer signaling.
(O10) The circuitry of any one of (O1) to (O9),
   wherein the operation of the mobile telecommunications system includes beam management.
(O11) The circuitry of any one of (O1) to (O10),
   wherein the operation of the mobile telecommunications system includes determining channel state information.
(O12) The circuitry of any one of (O1) to (O11),
   wherein the operation of the mobile telecommunications system includes positioning.
(P1) A method for a user equipment of a mobile telecommunication system, the method comprising:
   obtaining an inference result of a first machine learning model for an operation of the mobile telecommunications system, wherein the first machine learning model is executed by the user equipment;
   determining a confidence level of the inference result; and
   transmitting the inference result and an indication of the confidence level to a network of the mobile telecommunications system.
(P2) The method of (P1),
   wherein the transmitting of at least one of the inference result and the indication of the confidence level is based on physical layer signaling.
(P3) The method of (P1),
   wherein the transmitting of at least one of the inference result and the indication of the confidence level is based on Media Access Control layer signaling.
(p4) The method of (P1),
   wherein the transmitting of at least one of the inference result and the indication of the confidence level is based on Radio Resource Control layer signaling.
(P5) The method of any one of (P1) to (P4), wherein the method further comprises:
   receiving, in response to the transmitting of the inference result and the indication of the confidence level, from the network an instruction to synchronize the first machine learning model with a second machine learning model executed by the network for the operation of the mobile telecommunications system.
(p6) The method of (P5),
   wherein the synchronizing includes switching from the first machine learning model to another machine learning model that corresponds to the second machine learning model.
(P7) The method of (P5) or (P6),
   wherein the receiving of the instruction to synchronize the first machine learning model is based on physical layer signaling.
(P8) The method of (P5) or (P6),
   wherein the receiving of the instruction to synchronize the first machine learning model is based on Media Access Control layer signaling.
(P9) The method of (P5) or (P6),
   wherein the receiving of the instruction to synchronize the first machine learning model is based on Radio Resource Control layer signaling.
(P10) The method of any one of (P1) to (P9),
   wherein the operation of the mobile telecommunications system includes beam management.
(P11) The method of any one of (P1) to (P10),
   wherein the operation of the mobile telecommunications system includes determining channel state information.
(P12) The method of any one of (P1) to (P11),
   wherein the operation of the mobile telecommunications system includes positioning.
(Q1) A method for a mobile telecommunication system, the method comprising:
   receiving, from a user equipment of the mobile telecommunications system, an inference result of a first machine learning model and an indication of a confidence level of the inference result, wherein the first machine learning model is executed by the user equipment for an operation of the mobile telecommunications system;
   determining a mismatch between the inference result of the first machine learning model and an inference result of a second machine learning model executed by a network node of the mobile telecommunications system for the operation of the mobile telecommunications system; and
   deciding to synchronize the first machine learning model with the second machine learning model based on the confidence level of the inference result of the first machine learning model.
(Q2) The method of (Q1),
   wherein the receiving of at least one of the inference result and the indication of the confidence level is based on physical layer signaling.
(Q3) The method of (Q1),
   wherein the receiving of at least one of the inference result and the indication of the confidence level is based on Media Access Control layer signaling.
(Q4) The method of (Q1),
   wherein the receiving of at least one of the inference result and the indication of the confidence level is based on Radio Resource Control layer signaling.
(Q5) The method of any one of (Q1) to (Q4), wherein the method further comprises:
   transmitting, based on the decision to synchronize the first machine learning model and the second machine learning model, to the user equipment an instruction to synchronize the first machine learning model with the second machine learning model.
(Q6) The method of (Q5),
   wherein the synchronizing includes switching from the first machine learning model to another machine learning model that corresponds to the second machine learning model.
(Q7) The method of (Q5) or (Q6),
   wherein the transmitting of the instruction to synchronize the first machine learning model is based on physical layer signaling.
(Q8) The method of (Q5) or (Q6),
   wherein the transmitting of the instruction to synchronize the first machine learning model is based on Media Access Control layer signaling.
(Q9) The method of (Q5) or (Q6),
   wherein the transmitting of the instruction to synchronize the first machine learning model is based on Radio Resource Control layer signaling.
(Q10) The method of any one of (Q1) to (Q9),
   wherein the operation of the mobile telecommunications system includes beam management.
(Q11) The method of any one of (Q1) to (Q10),
   wherein the operation of the mobile telecommunications system includes determining channel state information.
(Q12) The method of any one of (Q1) to (Q11),
   wherein the operation of the mobile telecommunications system includes positioning.
(R1) A computer program comprising program code causing a computer to perform the method according to anyone of (P1) to (Q12), when being carried out on a computer.
(R2) A non-transitory computer-readable recording medium that stores therein a computer program product, which, when executed by a processor, causes the method according to anyone of (P1) to (Q12) to be performed.

1. A user equipment for a mobile telecommunications system, the user equipment comprising circuitry configured to:
obtain performance information indicating a performance of a first machine learning model for an operation of the mobile telecommunications system;
decide, based on the performance information, to switch to another machine learning model for the operation of the mobile telecommunications system, and
transmit to a network of the mobile telecommunications system an indication of the decision to switch.

2. The user equipment of claim 1,
wherein the decision to switch to another machine learning model includes determining, based on the performance information, that the performance of the first machine learning model satisfies a switching condition configured by the network for switching to another machine learning model for the operation of the mobile telecommunications system.

3. The user equipment of claim 1,
wherein the circuitry is further configured to switch, according to the decision to switch to another machine learning model, to a second machine learning model and execute an inference of the second machine learning model; and
wherein the transmitting of the indication of the decision to switch to another machine learning model includes reporting the switching to the second machine learning model to the network.

4. The user equipment of claim 1,
wherein the indication of the decision to switch to another machine learning model includes a request to switch to another machine learning model for the operation of the mobile telecommunications system.

5. The user equipment of claim 1,
wherein the operation of the mobile telecommunications system includes beam management.

6. The user equipment of claim 1,
wherein the operation of the mobile telecommunications system includes determining channel state information.

7. The user equipment of claim 1,
wherein the operation of the mobile telecommunications system includes positioning.

8. The user equipment of claim 1,
wherein the transmitting of the indication of the decision to switch to another machine learning model is based on physical layer signaling.

9. The user equipment of claim 1,
wherein the transmitting of the indication of the decision to switch to another machine learning model is based on Media Access Control layer signaling.

10. The user equipment of claim 1,
wherein the transmitting of the indication of the decision to switch to another machine learning model is based on Radio Resource Control layer signaling.

11. The user equipment of claim 1,
wherein the decision to switch to another machine learning model includes selecting a second machine learning model for switching; and
wherein the indication of the decision to switch identifies the selected second machine learning model.

12. The user equipment of claim 1,
wherein the indication of the decision to switch includes a selection request to select another machine learning model for switching; and
wherein the circuitry is further configured to receive from the network an indication of a selected second machine learning model for switching.

13. A base station for a mobile telecommunications system, the base station comprising circuitry configured to:
receive from a user equipment of the mobile telecommunications system an indication of a decision to switch from a first machine learning model for an operation of the mobile telecommunications system to another machine learning model for the operation of the mobile telecommunications system.

14. The base station of claim 13,
wherein the circuitry is further configured to configure a switching condition for switching to another machine learning model for the operation of the mobile telecommunications system.

15.-24. (canceled)

25. A circuitry for a mobile telecommunications system, the circuitry being configured to:
receive from a user equipment of the mobile telecommunications system an indication of a decision to switch from a first machine learning model for an operation of the mobile telecommunications system to another machine learning model for the operation of the mobile telecommunications system.

26. The circuitry of claim 25,
wherein the circuitry is further configured to configure a switching condition for switching to another machine learning model for the operation of the mobile telecommunications system.

27. The circuitry of claim 25,
wherein the receiving of the indication of the decision to switch to another machine learning model includes receiving a report that the user equipment has switched to the second machine learning model.

28. The circuitry of claim 25,
wherein the indication of the decision to switch to another machine learning model includes a request to switch to another machine learning model for the operation of the mobile telecommunications system; and
wherein the circuitry is further configured to switch to a second machine learning model according to the request.

29. The circuitry of claim 25,
wherein the operation of the mobile telecommunications system includes beam management.

30. The circuitry of claim 25,
wherein the operation of the mobile telecommunications system includes determining channel state information.

31.-135. (canceled)
